(19) United States
(12) Patent Application Publication
(10) Pub. No.: US 2026/0177951 A1
(43) Pub. Date: Jun. 25, 2026

(54) IMAGE FORMING APPARATUS

(71) Applicant: CANON KABUSHIKI KAISHA, Tokyo (JP)

(72) Inventors: KENICHI TAGAMI, Tokyo (JP); MASAFUMI MAEDA, Kanagawa (JP)

(21) Appl. No.: 19/423,043

(22) Filed: Dec. 17, 2025

(30) Foreign Application Priority Data
Dec. 19, 2024 (JP) 2024-224570

(51) Int. Cl. G03G 15/20; G03G 15/00; G03G 21/16; G03G 21/18

(52) U.S. Cl. CPC G03G 15/2032; G03G 15/2064; G03G 15/80; G03G 21/1619; G03G 21/1633; G03G 21/1647; G03G 21/1814; G03G 2215/2035; G03G 2221/1654

(57) ABSTRACT

An image forming apparatus includes a main body frame, a fixing unit disposed on the first end side of the main body frame, a shutter configured to move between a shielding position and an opening position, a cartridge detachably attached to the main body frame and disposed on the second end side with respect to the fixing unit, a rear opening/closing cover supported on the first end side of the main body frame, a changing mechanism configured to change a state of the fixing unit, a cover interlocking mechanism disposed on the third end side of the main body frame, and a shutter interlocking mechanism disposed on the third end side of the main body frame in the second direction, the shutter interlocking mechanism.

### BACKGROUND

### Field of the Technology

The present disclosure relates to an electrophotographic image forming apparatus.

### Description of the Related Art

Japanese Patent Application Publication No. 2010-243851 describes an image forming apparatus that includes a link mechanism that releases the pressure of a fixing nip portion in accordance with the opening operation of a door.

### SUMMARY

According to the present disclosure, a new image forming apparatus that advances conventional technology can be provided.

An aspect of the present disclosure is an image forming apparatus including a main body frame including a first end portion on a first end side in a first direction that is a horizontal direction, a second end portion on a second end side opposite to the first end side in the first direction, a third end portion on a third end side in a second direction that is a horizontal direction and that is orthogonal to the first direction, and a fourth end portion on a fourth end side opposite to the third end side in the second direction, a fixing unit disposed on the first end side of the main body frame in the first direction, the fixing unit including a heating unit and a pressing roller both configured to form a nip portion, the fixing unit being configured to fix a toner image to a sheet by heating the toner image while conveying the sheet through the nip portion, a shutter configured to move between a shielding position and an opening position, the shielding position being a position at which the shutter shields an inlet of the nip portion on an upstream side of the nip portion in a conveyance direction in which the sheet is conveyed through the nip portion, the opening position being a position at which the shutter opens the inlet of the nip portion, a cartridge detachably attached to the main body frame and disposed on the second end side with respect to the fixing unit in the first direction, the cartridge including a photosensitive drum configured to rotate around a rotation axis that extends in the second direction and a developing roller configured to develop the toner image on the photosensitive drum by supplying toner to the photosensitive drum, a rear opening/closing cover supported on the first end side of the main body frame in the first direction and configured to pivot with respect to the main body frame, the rear opening/closing cover being configured to rotate between an open position and a closed position, the opening position being a position at which the rear opening/closing cover is opened such that an access from the first end side of the main body frame to the fixing unit is allowed, the closed position being a position at which the rear opening/closing cover is closed such that the access from the first end side of the main body frame to the fixing unit is restricted, a changing mechanism configured to change a state of the fixing unit between a first state where a pressure of the nip portion is a first pressure and a second state where the pressure is a second pressure lower than the first pressure or is zero, a cover interlocking mechanism disposed on the third end side of the main body frame in the second direction, the cover interlocking mechanism being configured to interlock the changing mechanism and the rear opening/closing cover such that the fixing unit is in the first state in a case where the rear opening/closing cover is at the closed position, and the fixing unit is in the second state in a case where the rear opening/closing cover is at the open position, and a shutter interlocking mechanism disposed on the third end side of the main body frame in the second direction, the shutter interlocking mechanism being configured to interlock attachment and detachment of the cartridge and a position of the shutter such that the shutter is at the opening position in a state where the cartridge is attached to the main body frame, and the shutter is at the shielding position in a state where the cartridge is not attached to the main body frame.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram in which a first side plate of an embodiment is viewed from a left side.

FIG. 2 is a schematic diagram of an image forming apparatus of the embodiment.

FIG. 3 is a perspective view of the image forming apparatus of the embodiment.

FIG. 4 is a schematic diagram of a fixing apparatus of the embodiment.

FIG. 5 is a cross-sectional view of the fixing apparatus of the embodiment.

FIG. 6 is an exploded view of the fixing apparatus of the embodiment.

FIG. 7 is a perspective view of a cover interlocking mechanism and a changing mechanism of the embodiment.

FIG. 8 is a cross-sectional view of the cover interlocking mechanism and the fixing apparatus of the embodiment.

FIG. 9 is a cross-sectional view of the cover interlocking mechanism and the fixing apparatus of the embodiment.

FIG. 10A is a front view of the fixing apparatus of the embodiment.

FIG. 10B is a cross-sectional view of the fixing apparatus of the embodiment.

FIG. 10C is a cross-sectional view of the fixing apparatus of the embodiment.

FIG. 10D is a cross-sectional view of the fixing apparatus of the embodiment.

FIG. 11A is a cross-sectional view of the fixing apparatus of the embodiment.

FIG. 11B is a cross-sectional view of the fixing apparatus of the embodiment.

FIG. 12 is an exploded view of a frame of the fixing apparatus of the embodiment.

FIG. 13 is a perspective view illustrating a process cartridge of the embodiment.

FIG. 14 is a diagram in which a portion of the first side plate of the embodiment is viewed from a left side.

FIG. 15 is a diagram in which a portion of the first side plate of the embodiment is viewed from a right side.

FIG. 16A is a diagram illustrating a shutter interlocking mechanism of the embodiment.

FIG. 16B is a diagram illustrating the shutter interlocking mechanism of the embodiment.

FIG. 17A is a perspective view for illustrating an opening/closing operation of a shutter of the embodiment.

FIG. 17B is a perspective view for illustrating the opening/closing operation of the shutter of the embodiment.

FIG. 18A is a side view of the fixing apparatus for illustrating the opening/closing operation of the shutter of the embodiment.

FIG. 18B is a side view of the fixing apparatus for illustrating the opening/closing operation of the shutter of the embodiment.

FIG. 19A is a perspective view of the changing mechanism, the cover interlocking mechanism, and the shutter interlocking mechanism of the embodiment.

FIG. 19B is a perspective view of the changing mechanism, the cover interlocking mechanism, and the shutter interlocking mechanism of the embodiment.

FIG. 20 is a top view illustrating a positional relationship between the changing mechanism, the cover interlocking mechanism, and the shutter interlocking mechanism of the embodiment.

FIG. 21A is a diagram illustrating a positional relationship between the changing mechanism, the cover interlocking mechanism, and the shutter interlocking mechanism of the embodiment.

FIG. 21B is a diagram illustrating a positional relationship between the changing mechanism, the cover interlocking mechanism, and the shutter interlocking mechanism of the embodiment.

### DESCRIPTION OF THE EMBODIMENTS

Hereinafter, an embodiment of the present disclosure will be described with reference to the accompanying drawings.

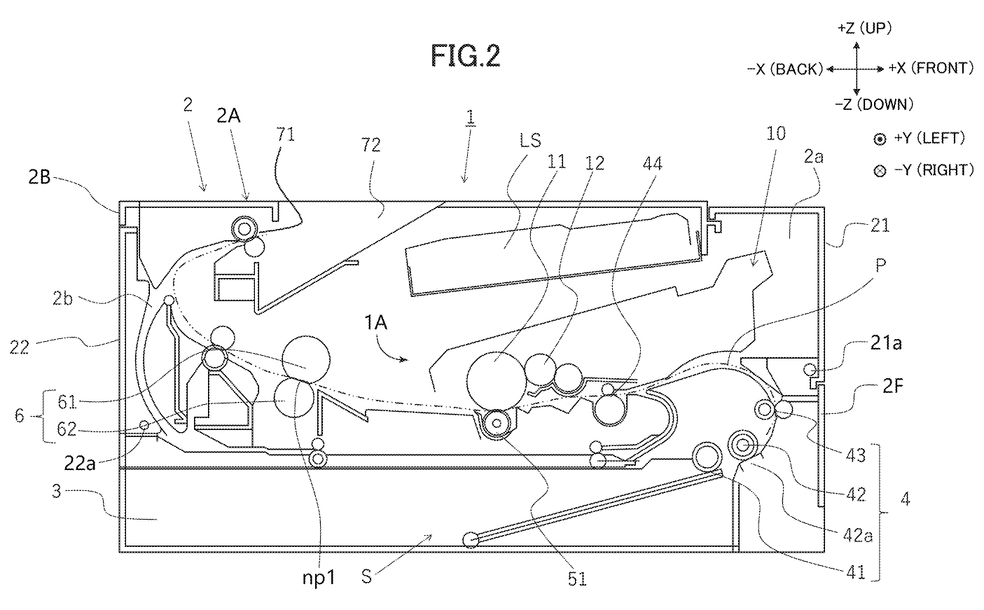

FIG. 2 is a cross-sectional view of an image forming apparatus 1 of an embodiment. The image forming apparatus 1 performs an image forming operation that is a series of operations that form an image on a sheet S while conveying the sheet S one by one. The image forming apparatus 1 of the present embodiment is a monochrome laser-beam printer that forms an image on the sheet S by using the electrophotographic process that uses laser beams. The sheet S that serves as a recording material (recording medium) may be any one of a variety of sheets with different sizes and materials. For example, the sheet S may be a paper sheet, such as a regular paper sheet or a thick paper sheet, a sheet material, such as a coated paper sheet, on which certain surface treatment has been performed, a specially-shaped sheet material, such as an envelope or an index paper sheet, a plastic film, or a cloth sheet.

In the present disclosure, the image forming apparatus may not be a single-function printer that performs the printing alone, and may be a copying machine or a multi-function printer. In addition, the image forming apparatus may include an image forming apparatus body including an image forming portion, and an attached apparatus (e.g., a document scanner, a finisher, or an option feeder) connected to the image forming apparatus body.

In the following description, a vertical direction in a case where the image forming apparatus 1 is placed on a horizontal plane is defined as a Z-axis direction. One of horizontal directions is defined as an X-axis direction. In addition, a direction orthogonal to both of the Z-axis direction and the X-axis direction is defined as a Y-axis direction. In the present embodiment, the X-axis direction may be referred to as a front-and-back direction of the image forming apparatus 1, and the Y-axis direction may be referred to as a right-and-left direction or a width direction of the image forming apparatus 1. If necessary, the direction of an arrow of each of the X, Y, and Z illustrated in each drawing is expressed with a plus symbol (+), and a direction opposite to the direction is expressed with a minus symbol (-).

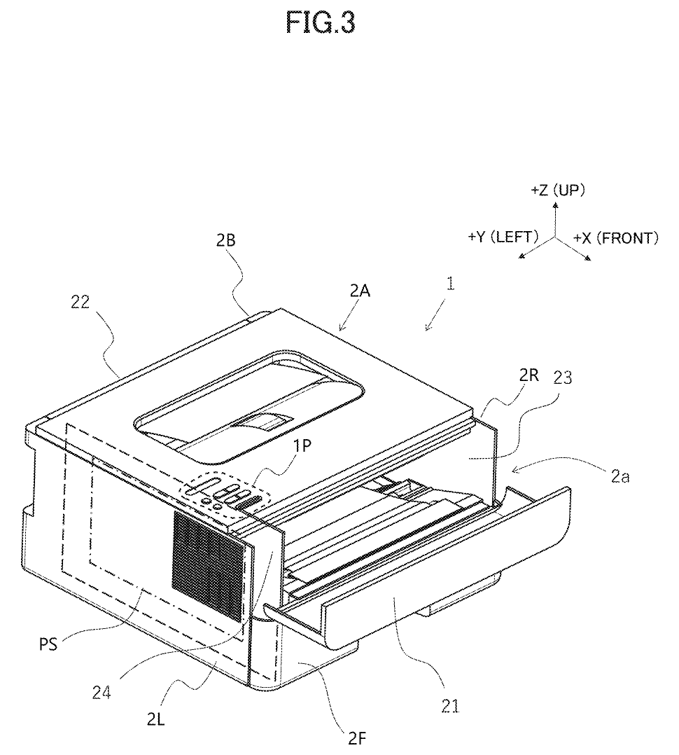

In the present embodiment, the +X direction may be referred to as a front side of a front-surface side of the image forming apparatus 1, and the -X direction may be referred to as a back side or a back-surface side of the image forming apparatus 1. In addition, the left side (i.e., +Y direction) in a case where the image forming apparatus 1 is viewed from the front-surface side may be referred to as a left side of the image forming apparatus 1, and the side (i.e., -Y direction) opposite to the left side may be referred to as a right side of the image forming apparatus 1 (see FIG. 3). In addition, the Y-axis direction is the rotation-axis direction of a photosensitive drum 11 included in the image forming apparatus 1, and the X-axis direction is one example of a direction that intersects the rotation-axis direction of the photosensitive drum 11.

Next, an overall configuration of the image forming apparatus 1 will be described with reference to FIG. 2. The image forming apparatus 1 includes an apparatus body 2, and a process cartridge 10 that can be attached to and detached from the apparatus body 2. In the present embodiment, the apparatus body 2 is a portion of the image forming apparatus 1 left after the process cartridge 10 is removed from the image forming apparatus 1.

The apparatus body 2 includes a feeding tray 3, a sheet feeding portion 4, a registration roller pair 44, a sheet conveyance path P, a transfer roller 51, a fixing apparatus 6, a discharging roller pair 71, a discharging tray 72, and a laser scanner LS. The process cartridge 10 includes the photosensitive drum 11, a charger such as a charging roller or a corona discharger, a developing roller 12, and a toner storage portion (developer container) that stores toner that serves as developer. The process cartridge 10, the laser scanner LS, and the transfer roller 51 constitute an image forming portion 1A that forms an image on the sheet S.

The apparatus body 2 also includes a main body frame 2A, a front opening/closing cover 21, and a rear opening/closing cover 22. In the main body frame 2A, a front opening 2a and a rear opening 2b are formed. Each of the front opening/closing cover 21 and the rear opening/closing cover 22 is supported by the main body frame 2A.

The front opening/closing cover 21 is a cover supported so as to be able to pivot with respect to the main body frame 2A, on the side of a front end portion 2F (i.e., a second end portion) of the main body frame 2A. The front opening/closing cover 21 includes a pivot shaft 21a supported by the main body frame 2A. The front opening/closing cover 21 can pivot with respect to the main body frame 2A, around a pivot axis that passes through the center of the pivot shaft 21a. The front opening/closing cover 21 can move between a closed position at which the front opening/closing cover 21 closes the front opening 2a, and an open position at which the front opening/closing cover 21 opens the front opening 2a. The pivot shaft 21a is disposed at a lower edge portion of the front opening/closing cover 21 that is positioned at the closed position. The process cartridge 10 can be attached to and detached from (or detachably attached to) the main body frame 2A through the front opening 2a, in a state where the front opening/closing cover 21 is positioned at the open position.

The rear opening/closing cover 22 is a cover supported so as to be able to pivot with respect to the main body frame 2A, on the side of a back end portion 2B (i.e., a first end portion) of the main body frame 2A. The rear opening/closing cover 22 includes a pivot shaft 22a supported by the main body frame 2A. The rear opening/closing cover 22 can pivot with respect to the main body frame 2A, around a pivot axis that passes through the center of the pivot shaft 22a. The rear opening/closing cover 22 can move between a closed position at which the rear opening/closing cover 22 closes the rear opening 2b, and an open position at which the rear opening/closing cover 22 opens the rear opening 2b. That is, the rear opening/closing cover 22 rotates between the open position and the closed position. The open position is a position at which the rear opening/closing cover 22 is opened so that the fixing apparatus 6 can be accessed from the side of the back end portion 2B (i.e., the first end portion) of the main body frame 2A. The closed position is a position at which the rear opening/closing cover 22 is closed so that the fixing apparatus 6 cannot be accessed from the side of the back end portion 2B (i.e., the first end portion) of the main body frame 2A. The pivot shaft 22a is disposed at a lower edge portion of the rear opening/closing cover 22 that is positioned at the closed position. In a state where the rear opening/closing cover 22 is positioned at the open position, a user can access the sheet conveyance path P through the rear opening 2b, and remove the sheet S (i.e., a jammed sheet) left in the apparatus body 2.

The photosensitive drum 11 is an electrophotographic photoreceptor in which a photosensitive layer made of organic photosensitive material or the like is formed on the outer circumferential portion of a cylindrical conductive base body. The photosensitive drum 11 can rotate around a rotation axis that extends in the right-and-left direction (i.e., the second direction). The developing roller 12 is a developer bearing member that bears toner stored in the toner storage portion. The developing roller 12 is configured to develop a toner image on the photosensitive drum 11 by supplying the toner to the photosensitive drum 11.

The laser scanner LS is an exposure apparatus that exposes the photosensitive drum 11. The laser scanner LS includes a laser light source and a scanning optical system. The scanning optical system scans the surface of the photosensitive drum 11 in a main scanning direction (i.e., the Y-axis direction) by guiding the beam from the laser light source, to the photosensitive drum 11. The laser scanner LS of the present embodiment is disposed above the process cartridge 10. Note that the exposure apparatus may be an LED exposure apparatus in which a plurality of LED elements arranged in the main scanning direction is used as a light source.

The feeding tray 3 is a storage portion that stacks and stores the sheet S. The sheet feeding portion 4 includes a feeding roller 41, a separation roller 42, a separation pad 42a, and a conveyance roller pair 43. The feeding roller 41 is an example of a feeding member that feeds the sheet S from the feeding tray 3. For example, the feeding roller 41 may be a belt-type feeding member. The separation pad 42a is an example of a separation member that separates the sheet S by using the frictional force. For example, the separation pad 42a may be a separation member formed in a roller.

The transfer roller 51 is an example of a transfer member that transfers a toner image. The transfer roller 51 is disposed so as to face the photosensitive drum 11. A transfer nip that serves as a transfer portion is formed between the photosensitive drum 11 and the transfer roller 51. The fixing apparatus 6 is a heat-fixing image fixing apparatus (image heating apparatus). The fixing apparatus 6 includes a heating unit 61 and a pressing roller 62. A nip portion np1 (i.e., a fixing nip) is formed between the heating unit 61 and the pressing roller 62. The fixing apparatus 6 will be described in detail below.

The discharging roller pair 71 is a discharging member that discharges the sheet S from the inside of the apparatus body 2 to the outside. The discharging tray 72 is a stacking portion that stacks the sheet S on which an image is formed. The discharging tray 72 of the present embodiment is formed in the top surface of the apparatus body 2.

The sheet conveyance path P is a path that extends from the feeding roller 41 to the discharging tray 72 through the nip portion between the separation roller 42 and the separation pad 42a, the conveyance roller pair 43, the registration roller pair 44, the transfer nip, the nip portion np1 of the fixing apparatus 6, and the discharging roller pair 71. The apparatus body 2 includes a plurality of guide members that form the sheet conveyance path P.

In addition, the image forming apparatus 1 includes an operation portion 1P configured to accept an operation for the image forming apparatus 1. The operation portion 1P is disposed in a left edge portion of the top surface of the apparatus body 2. The operation portion 1P includes a display portion and an input portion. The display portion includes a liquid crystal panel and LED lamps. The input portion includes an execution button for instructing the execution of an image forming operation, and selection buttons. In a case where a control portion of the image forming apparatus 1 detects a jam of the sheet S, the control portion can inform a user of the jam by causing the operation portion 1P to display a text message, blink a ramp, or issue a buzzer sound or voice message, for example.

### Image Forming Operation

Next, a flow of image forming operations will be described. For example, the control portion of the image forming apparatus 1 starts an image forming operation, based on image information that the control portion receives from an external apparatus. If the image forming operation is started, the sheet S stored in the feeding tray 3 is fed, one by one, to the sheet conveyance path P by the sheet feeding portion 4. The sheet S is fed to the registration roller pair 44, and the skew of the sheet S is corrected and the timing is adjusted by the registration roller pair 44. After that, the sheet S is conveyed toward the transfer nip.

In parallel with the conveyance of the sheet S, the formation of a toner image is started by the image forming portion 1A. The photosensitive drum 11 is driven and rotated by a driving source (motor) disposed in the apparatus body 2. The charger uniformly charges the surface of the photosensitive drum 11 so that the surface has a predetermined electric potential. The laser scanner LS exposes the surface of the photosensitive drum 11 by scanning the surface with a laser beam in accordance with the image information, and thereby forms an electrostatic latent image on the photosensitive drum 11. The developing roller 12 bears and supplies the toner to the photosensitive drum 11, and thereby develops the electrostatic latent image into a toner image.

The transfer roller 51 is applied with a voltage from a high-voltage board of the apparatus body 2. Thus, when the sheet S passes through the transfer nip, the toner image is transferred from the photosensitive drum 11 to the sheet S. After that, the image is fixed to the sheet S by the fixing apparatus 6. The fixing apparatus 6 fixes the unfixed image formed on the sheet S, to the surface of the sheet S by heating and pressing the unfixed image while causing the nip portion np1 formed between the heating unit 61 and the pressing roller 62 to nip and convey the sheet S. The sheet S that has passed through the fixing apparatus 6 is discharged to the discharging tray 72 via the discharging roller pair 71.

### Main-Body Frame

Next, the main body frame 2A of the apparatus body 2 will be described with reference to FIG. 3. FIG. 3 is a perspective view of the image forming apparatus 1. As illustrated in FIG. 3, the main body frame 2A that is a frame of the apparatus body 2 includes a first side plate 23 (i.e., a first frame member or a right side plate) and a second side plate 24 (i.e., a second frame member or a left side plate) disposed, separated from each other in the right-and-left direction (i.e., the Y-axis direction).

The main body frame 2A also includes the back end portion 2B and the front end portion 2F disposed in the front-and-back direction (i.e., the X-axis direction or a first direction) that is a horizontal direction. The back end portion 2B serves as a first end portion that is an end portion on a first end side. The front end portion 2F serves as a second end portion (i.e., an end portion on a second end side opposite to the first end side) opposite to the first end portion. In addition, the main body frame 2A includes a right-side end portion 2R and a left-side end portion 2L disposed in the right-and-left direction (i.e., the Y-axis direction or the second direction) that is a horizontal direction and is orthogonal to the front-and-back direction. The right-side end portion 2R serves as a third end portion (i.e., an end portion on a third end side). The left-side end portion 2L serves as a fourth end portion (i.e., an end portion on a fourth end side opposite to the third end side) opposite to the third end portion. The first side plate 23 is disposed on the right-side end portion 2R, and the second side plate 24 is disposed on the left-side end portion 2L.

Each of the first side plate 23 and the second side plate 24 extends in directions that intersect the right-and-left direction that is the rotation-axis direction of the photosensitive drum 11. Each of the first side plate 23 and the second side plate 24 is a metal plate that extends, for example, in the front-and-back direction and the vertical direction, and the thickness direction of each of the first side plate 23 and the second side plate 24 extends in the right-and-left direction.

In addition, an attachment space in which the process cartridge 10 is attached is formed between the first side plate 23 and the second side plate 24 in the right-and-left direction. In addition, as an example, the fixing apparatus 6 is disposed between the first side plate 23 and the second side plate 24 in the right-and-left direction. The first side plate 23 is positioned on one side (right side) of the process cartridge 10 and the fixing apparatus 6 in the right-and-left direction. The second side plate 24 is positioned on the other side (left side) of the process cartridge 10 and the fixing apparatus 6 in the right-and-left direction.

In the present embodiment, the fixing apparatus 6 is disposed on the back end portion 2B side (i.e., the first end portion side or the first end side) of the main body frame 2A in the front-and-back direction (i.e., the X-axis direction or the first direction) (FIG. 2). That is, the distance from the nip portion np1 to the back end portion 2B of the main body frame 2A in the front-and-back direction is shorter than the distance from the nip portion np1 to the front end portion 2F of the main body frame 2A in the front-and-back direction.

In addition, in the present embodiment, the process cartridge 10 is disposed on the front end portion 2F side (i.e., the second end portion side or the second end side) of the main body frame 2A in the front-and-back direction (i.e., the first direction). That is, the distance from the frontmost end of the process cartridge 10 to the front end portion 2F of the main body frame 2A in the front-and-back direction is shorter than the distance from the backmost end of the process cartridge 10 to the back end portion 2B of the main body frame 2A in the front-and-back direction.

In addition, a power supply board PS that serves as a power supply is disposed on the left-side end portion 2L (i.e., the fourth end portion) of the main body frame 2A. For example, the power supply board PS supplies electric power, for example, to the operation portion 1P and the driving source (motor) of the apparatus body 2. The operation portion 1P and the power supply board PS are disposed on a side opposite to a below-described cover interlocking mechanism 8 and shutter interlocking mechanism 9 in the right-and-left direction (i.e., the second direction). Thus, the electric circuit that includes the operation portion 1P and the power supply board PS, and the cover interlocking mechanism 8 and shutter interlocking mechanism 9 related to the fixing apparatus 6 can be arranged efficiently, so that the image forming apparatus 1 can be downsized.

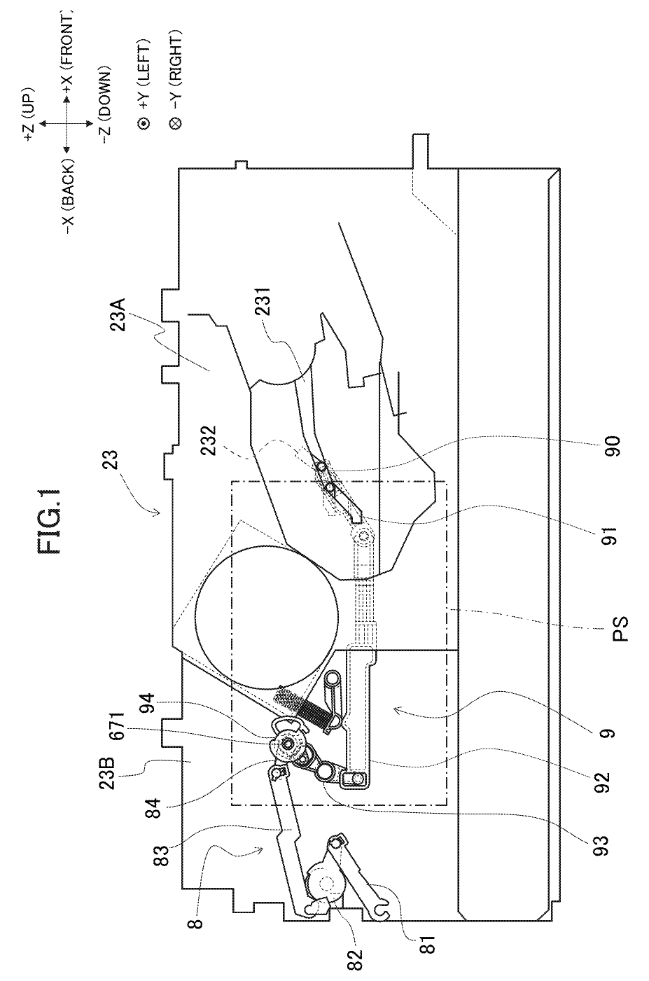

When the image forming apparatus 1 is viewed in the right-and-left direction, at least a portion of the cover interlocking mechanism 8 and/or at least a portion of the shutter interlocking mechanism 9 may overlap with the power supply board PS (FIG. 1).

### Fixing Apparatus

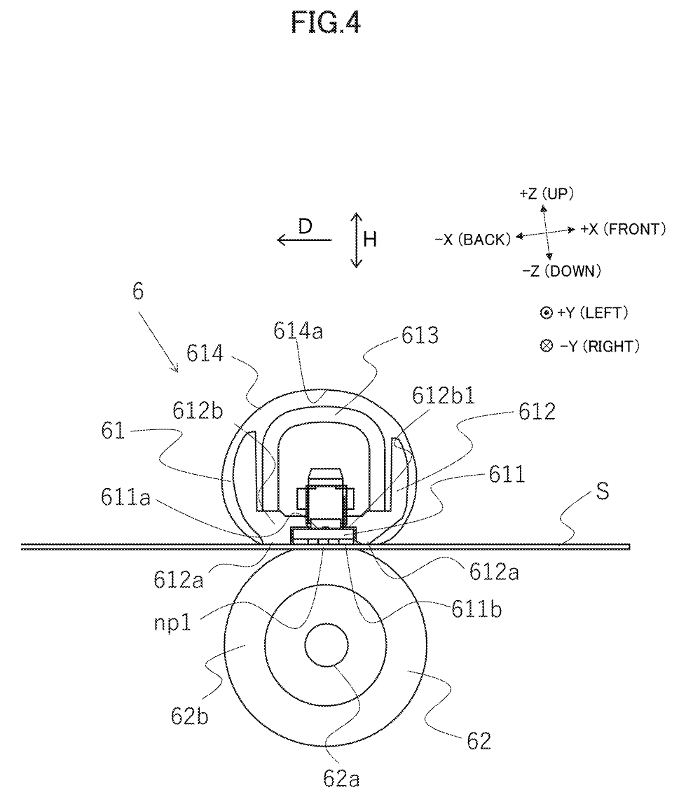

Next, a configuration of the fixing apparatus 6 that serves as a fixing unit of the present embodiment will be described. FIG. 4 is a schematic diagram in which the fixing apparatus 6 is viewed in the right-and-left direction. As illustrated in FIG. 4, the fixing apparatus 6 includes the heating unit 61 and the pressing roller 62 that form the nip portion np1. The fixing apparatus 6 fixes a toner image to the sheet S by heating the toner image, while conveying the sheet S in the nip portion np1.

The heating unit 61 includes a heater 611, a holder 612, a stay 613, and a belt 614. Each of the heater 611, the holder 612, the stay 613, and the belt 614 is a member thin and elongated in the right-and-left direction. The pressing roller 62 rotates around a rotation axis that extends in the right-and-left direction. Hereinafter, the right-and-left direction may be referred to as a longitudinal direction of the fixing apparatus 6.

The belt 614 is a rotatable heating member. The belt 614 may be an endless (tubular) film. The heater 611 is disposed on the inner surface side of the belt 614, and heats the belt 614. The heater 611 is formed in a plate whose thickness direction intersects both of a sheet conveyance direction D and the longitudinal direction (i.e., the Y-axis direction). The heater 611 includes a first surface 611a and a second surface 611b opposite to the first surface 611a. The first surface 611a is supported by the holder 612.

For example, the holder 612 is made of a resin, such as polyphenylene sulfide (PPS) or liquid crystal polymer, that has heat resistance. The holder 612 includes a guide surface 612a and a support wall 612b. The guide surface 612a is in contact with an inner circumferential surface 614a of the belt 614, and guides the belt 614. The support wall 612b includes a support surface 612b1 that abuts against the first surface 611a of the heater 611 and supports the heater 611. The stay 613 is a member (i.e., a support member or a reinforcement member) that supports the holder 612. The stay 613 is a plate member whose stiffness is larger than that of the holder 612. For example, the stay is a metal member formed by bending a steel plate that has, for example, a thickness of 1.6 mm, in a substantially U shape.

The belt 614 is an endless belt that has heat resistance and flexibility. For example, the belt 614 may be a belt in which a metal sleeve made of stainless steel is coated with fluoropolymer, or in which the metal sleeve is laminated with polyimide resin, silicon rubber, fluoropolymer, or the like. The heater 611, the holder 612, and the stay 613 are disposed inside the belt 614, and the belt 614 rotates around the heater 611, the holder 612, and the stay 613. The inner circumferential surface 614a of the belt 614 is in contact with the second surface 611b of the heater 611, and the belt 614 is heated by the heat transmitted from the heater 611.

The pressing roller 62 (i.e., a rotary pressing member) includes a shaft 62a made of metal, and an outer circumferential portion 62b that is an elastic member that covers the shaft 62a. The pressing roller 62 is pressed by the heater 611 via the belt 614. Thus, the nip portion np1 for heating and pressing the sheet S while nipping the sheet S is formed between the belt 614 and the pressing roller 62. That is, the pressing roller 62 and the heater 611 form the nip portion np1 by sandwiching the belt 614 therebetween.

Hereinafter, the conveyance direction of the sheet S in the nip portion np1 is referred to as a sheet conveyance direction D in the fixing apparatus 6, or simply as a sheet conveyance direction D. The sheet conveyance direction D is a direction (i.e., the -X direction) that extends from the front side toward the back side of the image forming apparatus 1 in the front-and-back direction. In addition, a direction orthogonal to both of the sheet conveyance direction D and the longitudinal direction (i.e., the Y-axis direction) is referred to as a nip pressing direction H.

The pressing roller 62 is rotated by the driving force transmitted from a driving source included in the image forming apparatus 1. The rotation of the pressing roller 62 applies force to the belt 614 in the nip portion np1, so that the belt 614 is rotated by the force that the belt 614 receives from the pressing roller 62, in accordance with the rotation of the pressing roller 62.

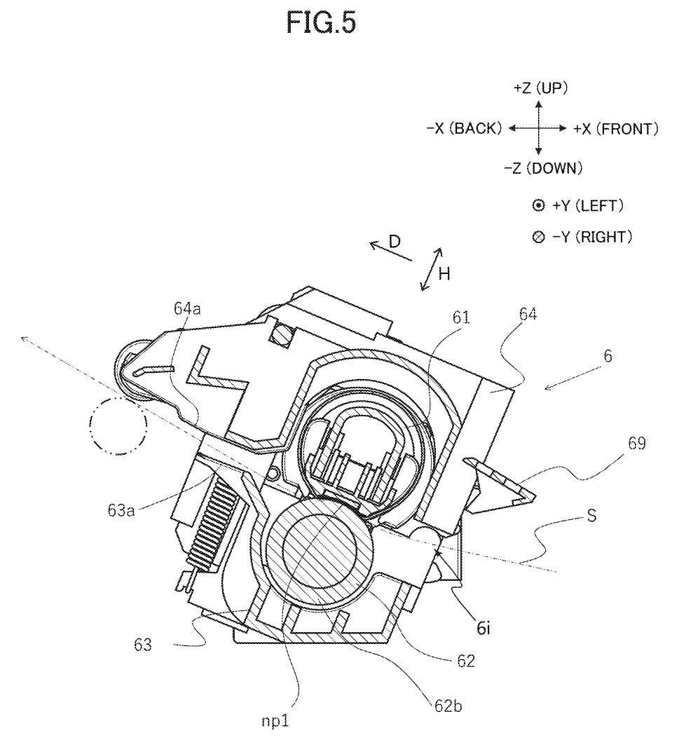

Next, a frame configuration of the fixing apparatus 6 and a shutter 69 will be described with reference to FIG. 5. FIG. 5 is a cross-sectional view illustrating a cross section of the fixing apparatus 6, taken along an imaginary plane perpendicular to the longitudinal direction of the fixing apparatus 6. The fixing apparatus 6 includes an upper frame 64 and a lower frame 63. The lower frame 63 may be referred to as a first frame, and the upper frame 64 may be referred to as a second frame.

The lower frame 63 is a frame that supports the heating unit 61 and the pressing roller 62. The upper frame 64 is positioned above the lower frame 63, and covers the heating unit 61. Each of the lower frame 63 and the upper frame 64 may be a resin member constituted by a nonconductive molded member (resin member). The upper frame 64 includes an upper guide surface 64a disposed downstream of the heating unit 61 in the sheet conveyance direction D. The upper guide surface 64a guides the upper surface of the sheet S conveyed in the sheet conveyance direction D. The lower frame 63 includes a lower guide surface 63a disposed downstream of the heating unit 61 in the sheet conveyance direction D. The lower guide surface 63a guides the lower surface of the sheet S conveyed in the sheet conveyance direction D.

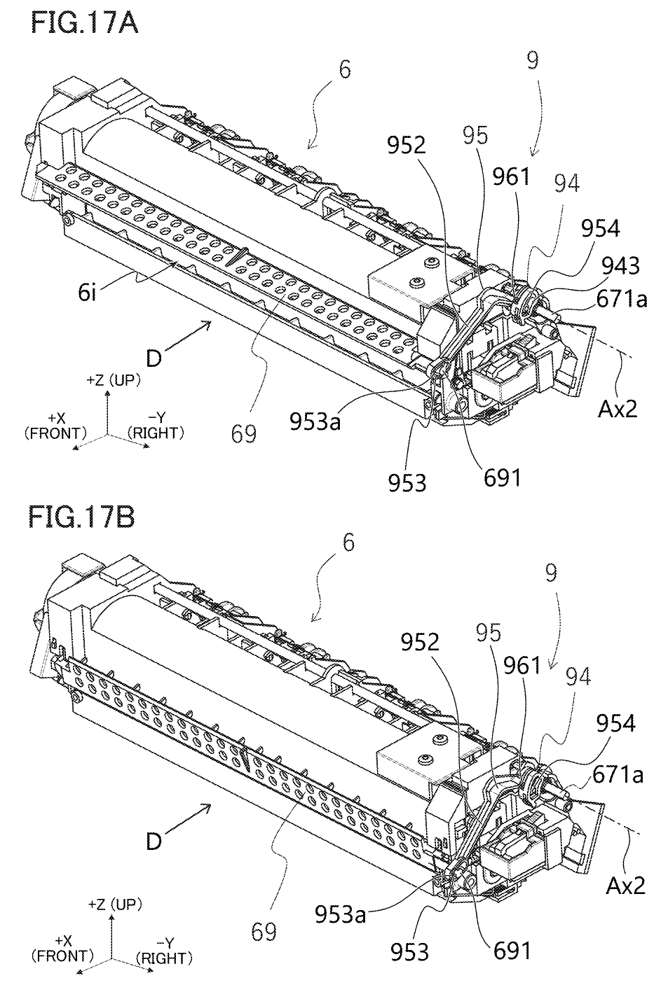

In addition, the fixing apparatus 6 includes the shutter 69 and an inlet 6i. The inlet 6i is opened toward the upstream side in the conveyance direction (i.e., the sheet conveyance direction D) in which the nip portion np1 conveys the sheet S. The inlet 6i is an opening portion through which the fixing apparatus 6 takes in the sheet S on the upstream side of the nip portion np1. The inlet 6i is formed between the upper frame 64 and the lower frame 63. The shutter 69 can move between a shielding position (see also FIG. 17B) at which the shutter 69 shields the inlet 6i, and an opening position (see also FIG. 17A) at which the shutter 69 opens the inlet 6i. The shutter 69 of the present embodiment is supported by the upper frame 64, and pivots around a pivot axis that extends in the right-and-left direction.

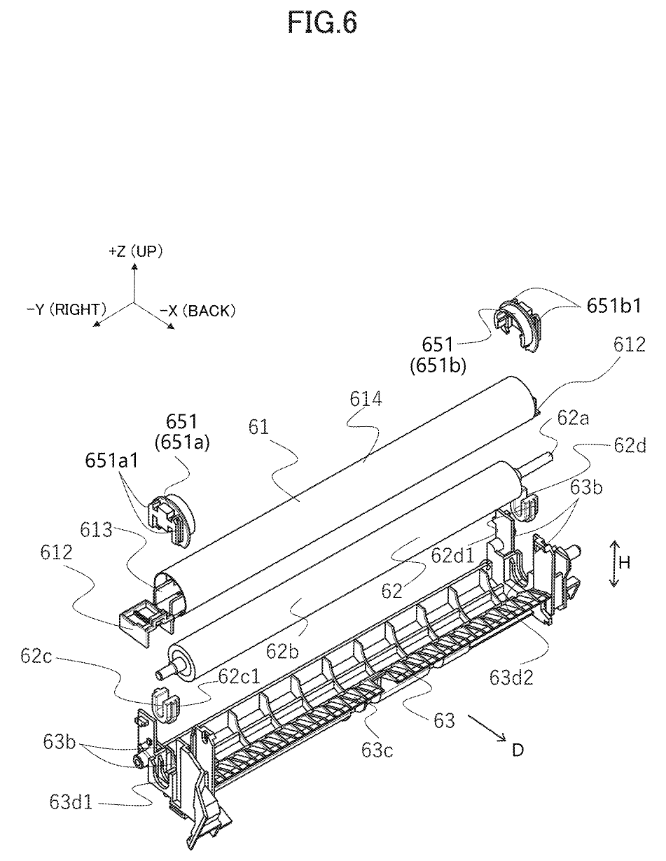

The configuration of the lower frame 63 will be further described with reference to FIG. 6. FIG. 6 is an exploded perspective view of the fixing apparatus 6. The lower frame 63 includes rails 63b disposed in both end portions in the Y-axis direction, which is the longitudinal direction of the fixing apparatus 6. Each of the rails 63b extends in the nip pressing direction H orthogonal to both of the sheet conveyance direction D and the longitudinal direction (i.e., the Y-axis direction).

The two rails 63b face each other in the longitudinal direction of the fixing apparatus 6. The rails 63b engage with corresponding groove portions 651a1 and 651b1 formed in below-described two transmission members 651 (i.e., transmission members 651a and 651b). The transmission members 651 are supported by the rails 63b so as to be able to move in the nip pressing direction H.

In addition, the fixing apparatus 6 includes shaft receiving members 62c and 62d. One end portion of the shaft 62a of the pressing roller 62 is rotatably supported by one shaft receiving member 62c, and the other end portion of the shaft 62a is rotatably supported by the other shaft receiving member 62d. A projection portion 62c1 of the shaft receiving member 62c fits in a recess portion 63d1 (i.e., a groove portion) formed in the lower frame 63, so that the shaft receiving member 62c is positioned. Similarly, a projection portion 62d1 of the shaft receiving member 62d fits in a recess portion 63d2 (i.e., a groove portion) formed in the lower frame 63, so that the shaft receiving member 62d is positioned. The shaft receiving member 62c has conductivity. In the present embodiment, the projection portions 62c1 and 62d1 are respectively formed in the shaft receiving members 62c and 62d, and the recess portions 63d1 and 63d2 are formed in the lower frame 63. However, the recess portions 63d1 and 63d may be respectively formed in the shaft receiving members 62c and 62d, and the projection portions 62c1 and 62d1 may be formed in the lower frame 63. In another case, the shaft receiving members 62c and 62d may be fixed to the lower frame 63 in another method other than the method in which a recess portion (i.e., a groove portion) and a projection portion fit to each other.

### Pressing Mechanism

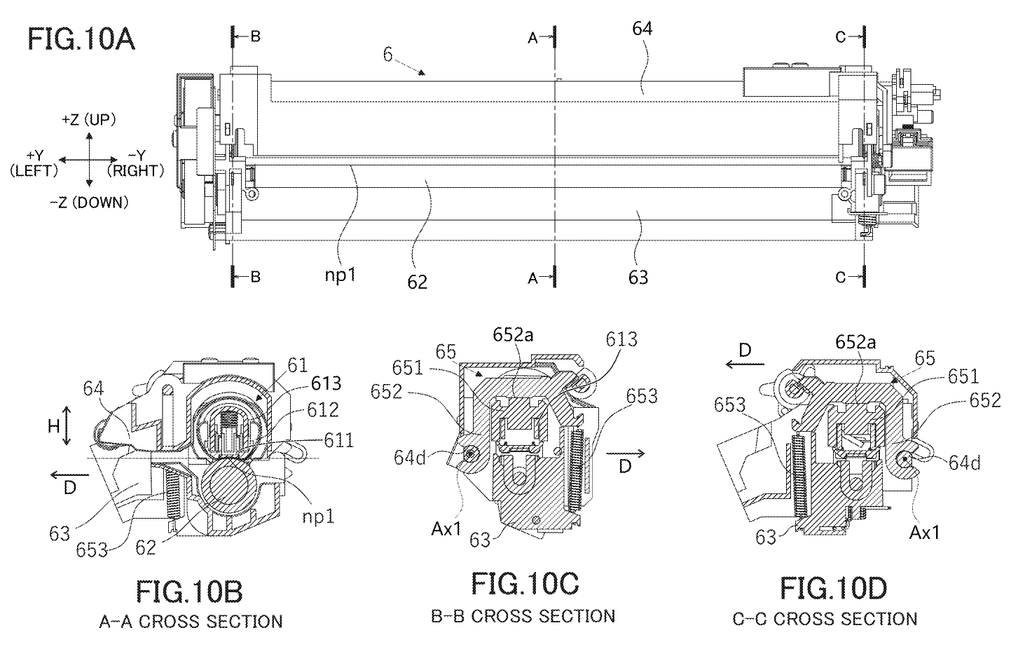

Next, a pressing mechanism of the fixing apparatus 6 will be described. FIG. 10A is a diagram (front view) in which the fixing apparatus 6 is viewed in the sheet conveyance direction D. FIG. 10B is a cross-sectional view of the fixing apparatus 6, taken along a line A-A of FIG. 10A. FIG. 10C is a cross-sectional view of the fixing apparatus 6, taken along a line B-B of FIG. 10A. FIG. 10D is a cross-sectional view of the fixing apparatus 6, taken along a line C-C of FIG. 10A.

As illustrated in FIGS. 10A to 10D, the fixing apparatus 6 includes a pressing mechanism 65 for pressing the nip portion np1. The pressing mechanism 65 of the present embodiment presses the heating unit 61 against the pressing roller 62.

The pressing mechanism 65 is disposed at each of an end portion of the lower frame 63 in the +Y direction and an end portion of the lower frame 63 in the -Y direction. That is, it can also be said that the pressing mechanism 65 is supported by the lower frame 63. Note that the configuration of the pressing mechanism 65 disposed at the end portion of the lower frame 63 in the +Y direction and the configuration of the pressing mechanism 65 disposed at the end portion of the lower frame 63 in the -Y direction are substantially the same as each other. Thus, in the following description, the pressing mechanism 65 will be described without distinguishing the two pressing mechanisms 65 from each other.

As illustrated in FIGS. 10B, 10C, and 10D, the pressing mechanism 65 includes the transmission member 651, a pressing arm 652, and a pressing spring 653. The pressing arm 652 is supported by the lower frame 63. More specifically, the pressing arm 652 is supported by a support portion 64d of the lower frame 63, and can pivot around a rotation axis Ax1 of the support portion 64d. The support portion 64d is a substantially cylindrical projection.

The pressing arm 652 includes a pressing portion 652a that abuts against the transmission member 651 from above and presses the transmission member 651 downward. The transmission member 651 transmits the pressing force applied from the pressing arm 652 to the transmission member 651, to the stay 613. Since the stay 613 receives the pressing force, the holder 612 and the heater 611 supported by the stay 613 are pushed against the pressing roller 62.

The pressing spring 653 urges the pressing arm 652 toward a direction in which the pressing portion 652a presses the transmission member 651. That is, the pressing spring 653 is an urging member that urges the pressing arm 652 so that the nip portion np1 is pressed. For example, the pressing spring 653 is a conductive tension coil spring. One end 653b of the pressing spring 653 is engaged with the lower frame 63, and the other end 653a of the pressing spring 653 is engaged with the pressing arm 652.

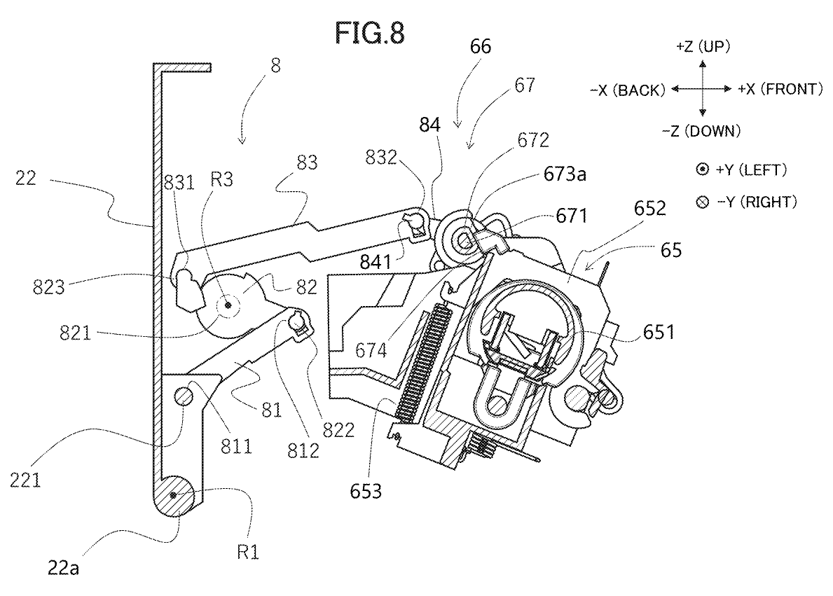

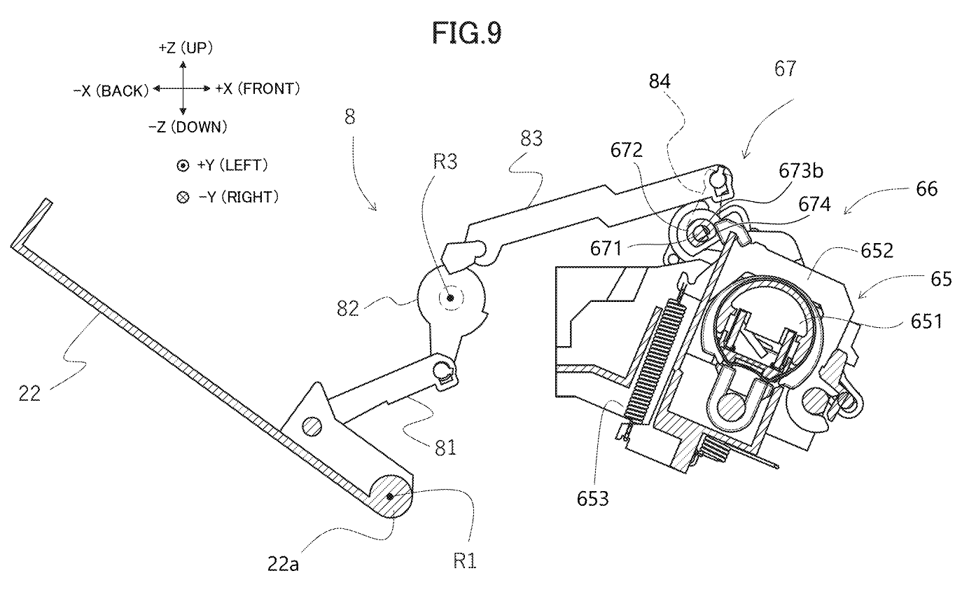

In addition, the pressing arm 652 includes an abutment portion 674 (FIGS. 8 and 9) that abuts against a cam 672 of a pressure release mechanism 67.

### Pressure Release Mechanism

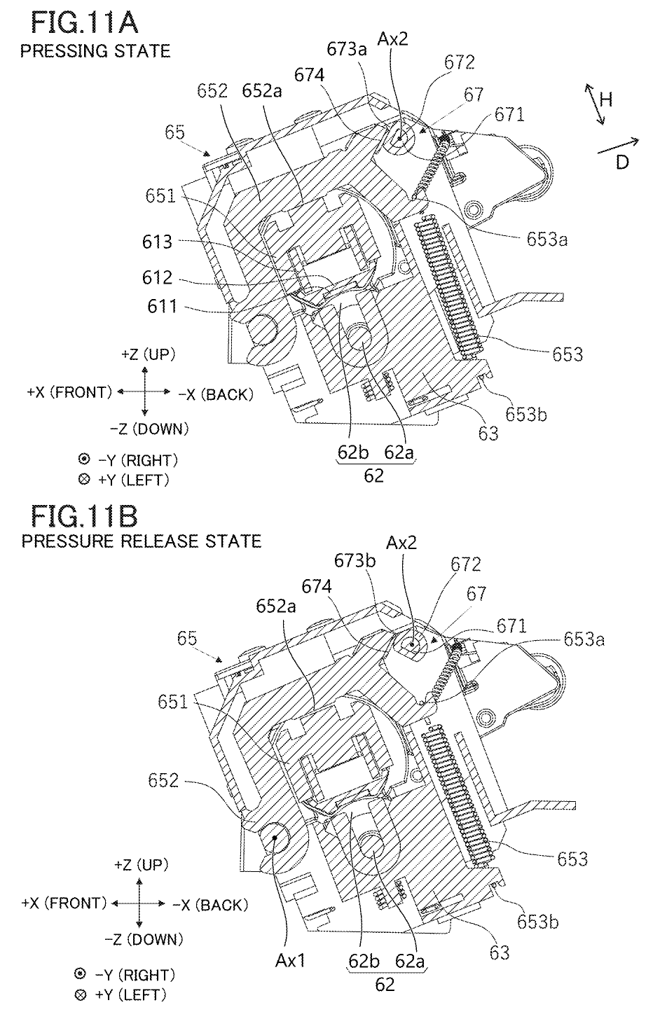

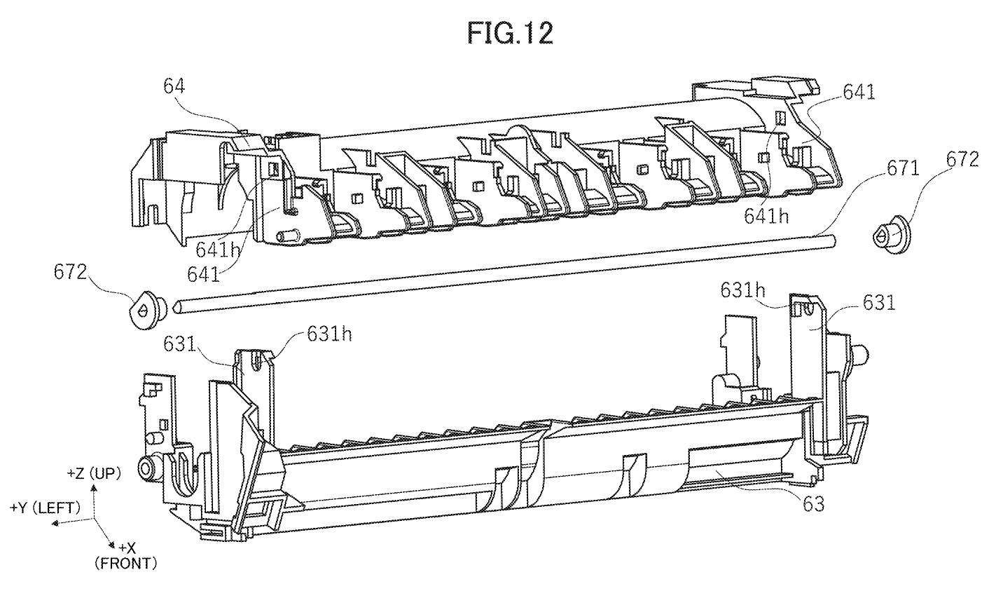

Next, a configuration of the pressure release mechanism 67 that is included in the fixing apparatus 6 and that releases the pressure will be described with reference to FIGS. 11A, 11B, and 12. The pressure release mechanism 67 is a mechanism (i.e., a pressure release portion) that changes the nip pressure of the nip portion np1 between the heating unit 61 and the pressing roller 62.

Each of FIGS. 11A and 11B is a cross-sectional view of the fixing apparatus 6. FIG. 11A illustrates a pressing state where the pressure release mechanism 67 allows the pressure of the nip portion np1. FIG. 11B illustrates a pressure release state where the pressure release mechanism 67 releases the pressure of the nip portion np1. FIG. 12 is an exploded perspective view illustrating the upper frame 64, the lower frame 63, and a cam shaft 671 of the fixing apparatus 6. In FIG. 12, some components including the heating unit 61 and the pressing roller 62 of the fixing apparatus 6 are not illustrated.

As illustrated in FIGS. 11A, 11B, and 12, the pressure release mechanism 67 includes the cam shaft 671 and the cam 672.

As illustrated in FIG. 11A, the cam shaft 671 can pivot around a rotation axis Ax2 (i.e., a second rotation axis). The cam shaft 671 is a shaft member that extends in an axial direction that is equal to the right-and-left direction (i.e., the longitudinal direction of the fixing apparatus 6). The cam shaft 671 is made of a conductive material, such as metal.

As illustrated in FIG. 12, the cam 672 is attached to each of an end portion of the cam shaft 671 in the +Y direction and an end portion of the cam shaft 671 in the -Y direction. The cam 672 is supported by the cam shaft 671 so as to pivot together with the cam shaft 671. One cam 672 is positioned at an end portion of the lower frame 63 in the +Y direction, and the other cam 672 is positioned at an end portion of the lower frame 63 in the -Y direction. The two cams 672 are the same as each other in shape and rotation phase.

The cam 672 can pivot between a pressing position illustrated in FIG. 11A and a pressure release position illustrated in FIG. 11B. The state of the fixing apparatus 6 where the cam 672 is located at the pressing position is referred to as a pressing state, and the state of the fixing apparatus 6 where the cam 672 is located at the pressure release position is referred to as a pressure release state.

It can be said that the pressing state is a first state where the pressure of the nip portion np1 is a first pressure. In addition, it can be said that the pressure release state is a second state where the pressure of the nip portion np1 is a second pressure lower than the first pressure. Note that the pressure of the nip portion np1 in the second state may be zero. That is, in a case where the cam 672 is located at the pressure release position, the heating unit 61 may be in a state (i.e., a non-contact state) where heating unit 61 is separated from the pressing roller 62.

The cam 672 can move the pressing arm 652 against the urging force of the pressing spring 653. That is, the position of the pressing arm 652 around the rotation axis Ax1 is changed by the rotation of the cam 672, so that the position of the transmission member 651, the stay 613, the holder 612, and the heater 611 is changed in the nip pressing direction H. As a result, the amount of entering of the heating unit 61 to the pressing roller 62 changes. The amount of entering is a distance by which the outer circumferential surface of the pressing roller 62 is displaced in the nip pressing direction H, by the force that the pressing roller 62 receives from the heating unit 61 in the nip portion np1. The distance is determined with respect to the position of the outer circumferential surface of the pressing roller 62 that is in a state where the outer circumferential portion 62b that is an elastic member is not elastically deformed. In this manner, a changing mechanism 66 changes the amount of entering of the heating unit 61 to the pressing roller 62 in accordance with the rotation angle of the cam 672, and thereby changes the pressure (i.e., the nip pressure) applied between the belt 614 and the pressing roller 62 in the nip pressing direction H in the nip portion np1.

Note that the moment of force received by the pressing arm 652 and produced around the rotation axis Ax1 due to the urging force of the pressing spring 653 is in balance with the moment received by the pressing arm 652 and produced by the reaction force received by the abutment portion 674 from the cam 672 and the reaction force received by the pressing portion 652a from the transmission member 651. In other words, in the above-described change in the nip pressure, the ratio of distribution of urging force between the abutment portion 675 and the pressing portion 652a changes in accordance with the rotation angle of the cam 672 while the balancing condition is satisfied. In other words, the changing mechanism 66 causes the pressing arm 652 to change the pressing force of the heating unit 61 to the pressing roller 62 in accordance with the rotation of the cam 672.

The cam 672 of the present embodiment includes a first cam surface 673a and a second cam surface 673b. The second cam surface 673b is formed in a circular arc whose center is equal to the rotation axis Ax2 of the cam shaft 671. The first cam surface 673a corresponds to an edge surface obtained by cutting a circumference whose center is equal to the rotation axis Ax2, with a straight line. The minimum value of the distance from the rotation axis Ax2 to the first cam surface 673a is smaller than the distance from the rotation axis Ax2 to the second cam surface 673b.

The pressing position of the cam 672 is a position at which the first cam surface 673a abuts against the abutment portion 674 of the pressing arm 652. The pressure release position of the cam 672 is a position at which the second cam surface 673b abuts against the abutment portion 674 of the pressing arm 652.

Next, a configuration for supporting the cam shaft 671 will be described with reference to FIG. 12. The lower frame 63 includes a support wall 631 that supports the cam shaft 671. The support wall 631 is disposed at each of an end portion of the lower frame 63 in the +Y direction and an end portion of the lower frame 63 in the -Y direction. The support wall 631 extends in the nip pressing direction H. Each support wall 631 includes a hole 631h that pivotally supports the cam shaft 671. The hole 631h is formed so as to pass through the support wall 631 in the longitudinal direction of the fixing apparatus 6. The two holes 631h may be the same as each other in shape. The cam shaft 671 is inserted into the holes 631h.

The upper frame 64 includes a support wall 641 that supports the cam shaft 671. The support wall 641 extends in the nip pressing direction H. The support wall 641 is disposed at each of an end portion of the upper frame 64 in the +Y direction and an end portion of the upper frame 64 in the -Y direction. Each support wall 641 includes a hole 641h that pivotally supports the cam shaft 671. The hole 641h is formed so as to pass through the support wall 641 in the longitudinal direction of the fixing apparatus 6. The two holes 641h may be the same as each other in shape. The cam shaft 671 is inserted into the holes 641h.

Each of the support wall 631 of the lower frame 63 and the support wall 641 of the upper frame 64 functions as a shaft support portion that supports the cam shaft 671. The shaft support portion may be any one of the support wall 631 of the lower frame 63 and the support wall 641 of the upper frame 64.

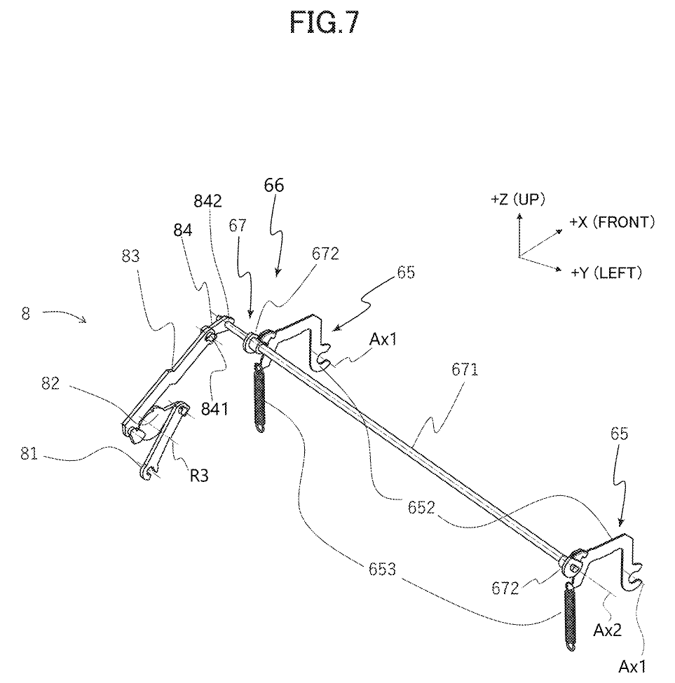

Note that as illustrated in FIG. 7, a fourth link 84 is attached to an end portion of the cam shaft 671 in the -Y direction, outside the cam 672. The fourth link 84 is supported so as to pivot together with the cam shaft 671. The fourth link 84 projects toward a direction that intersects the rotation axis Ax2 of the cam shaft 671, and a boss 841 is formed on a leading end portion of the fourth link 84. The boss 841 is linked to a below-described third link 83 of the cover interlocking mechanism 8. The base end portion of the fourth link 84 is a support portion 842 fixed to the cam shaft 671.

It can be said that the fourth link 84 is a linking portion in which the changing mechanism 66 and the cover interlocking mechanism 8 are linked to each other. The fourth link 84 is a member that pivots together with the cam shaft 671, and constitutes a portion of the pressure release mechanism 67. In addition, it can also be said that the fourth link 84 is a portion of a link mechanism that, together with links 81 to 83 of the cover interlocking mechanism 8, transmits force for pivoting the cam shaft 671 in accordance with the opening/closing operation of the rear opening/closing cover 22. Thus, it can also be said that the fourth link 84 is a portion of the cover interlocking mechanism 8.

### Changing Mechanism

Both of the above-described pressing mechanism 65 and pressure release mechanism 67 constitute the changing mechanism 66 that changes the state of the fixing apparatus 6 related to the pressure of the nip portion np1. That is, the image forming apparatus 1 includes the changing mechanism 66 that changes the state of the fixing apparatus 6, and the changing mechanism 66 includes the pressing mechanism 65 and the pressure release mechanism 67.

Thus, the changing mechanism 66 changes the state of the fixing apparatus 6 between the first state where the pressure of the nip portion np1 is the first pressure, and the second state where the pressure of the nip portion np1 is the second pressure that is lower than the first pressure or is zero.

The changing mechanism 66 includes the pressing arm 652 (i.e., an arm) that presses the heating unit 61 toward the pressing roller 62, and the pressing spring 653 (i.e., an urging member) that urges the pressing arm 652. The pressing spring 653 urges the pressing arm 652 so that the heating unit 61 is pressed toward the pressing roller 62 by the pressing arm 652. In addition, the changing mechanism 66 includes the cam 672 that rotates around the second rotation axis (the rotation axis of the photosensitive drum 11 is the first rotation axis). The cam 672 moves the pressing arm 652 between a first position at which the fixing apparatus 6 is in the pressing state (i.e., the first state), and a second position at which the fixing apparatus 6 is in the pressure release state (i.e., the second state), by rotating around the second rotation axis.

### Cover Interlocking Mechanism

Next, the cover interlocking mechanism 8 will be described with reference to FIGS. 7 to 9. The cover interlocking mechanism 8 is a link mechanism that moves the pressure release mechanism 67 in accordance with the opening/closing operation of the rear opening/closing cover 22.

FIG. 7 is a perspective view of the cover interlocking mechanism 8. Each of FIGS. 8 and 9 is a diagram illustrating the cover interlocking mechanism 8, the rear opening/closing cover 22, the pressure release mechanism 67, and the fixing apparatus 6. Specifically, each of FIGS. 8 and 9 is a cross-sectional view illustrating a cross section of a portion of the image forming apparatus 1, taken along an imaginary plane perpendicular to the right-and-left direction. FIG. 8 illustrates a state where the rear opening/closing cover 22 is positioned at the closed position, and FIG. 9 illustrates a state where the rear opening/closing cover 22 is positioned at the open position.

As illustrated in FIGS. 7 to 9, the cover interlocking mechanism 8 connects (links) the pressure release mechanism 67 and the rear opening/closing cover 22. That is, the cover interlocking mechanism 8 connects (links) the changing mechanism 66 and the rear opening/closing cover 22. The cover interlocking mechanism 8 is disposed on the right side and back side of the apparatus body 2.

The cover interlocking mechanism 8 includes a first link 81, a second link 82, the third link 83, and the fourth link 84.

The first link 81 is engaged with the rear opening/closing cover 22. The second link 82 is engaged with the first link 81, and can rotate around a rotation axis (i.e., a third rotation axis) that extends in the right-and-left direction (i.e., the second direction). The third link 83 is engaged with both of the second link 82 and the changing mechanism 66. The third link 83 can move in a direction that extends from the back end portion 2B (i.e., the first end portion) toward the front end portion 2F (i.e., the second end portion) of the main body frame 2A, and in a direction that extends from the front end portion 2F (i.e., the second end portion) toward the back end portion 2B (i.e., the first end portion) of the main body frame 2A. The fourth link 84 is engaged with the third link 83, and can rotate around a rotation axis (i.e., a fourth rotation axis) that extends in the right-and-left direction (i.e., the second direction).

Hereinafter, components of the cover interlocking mechanism 8 will be more specifically described. The first link 81 is a substantially linear member linked with the rear opening/closing cover 22. The first link 81 includes a hole portion 811 formed on the first end side, and a hole portion 812 formed on the second end side. The hole portion 811 pivotally fits to a boss 221 of the rear opening/closing cover 22. The boss 221 of the rear opening/closing cover 22 is disposed at a position different from the position of a pivot axis R1 of the rear opening/closing cover 22 (that is, at a position above the pivot axis R1 in a state where the rear opening/closing cover 22 is positioned at the closed position).

The second link 82 is a substantially circular plate shaped member linked with the first link 81. The second link 82 is supported by a boss 821 so as to be able to pivot around a pivot axis R3. The boss 821 projects from the first side plate 23. The second link 82 includes a first arm portion and a boss 822. The first arm portion projects out of the circular plate, toward a direction that intersects the pivot axis R3. The boss 822 projects from the leading end of the first arm portion in the +Y direction. The boss 822 pivotally fits in the hole portion 812 of the first link 81. In addition, the second link 82 includes a second arm portion and a boss 823. The second arm portion projects out of the circular plate, toward a direction that intersects the pivot axis R3 and that is opposite to the first arm portion. The boss 823 projects from the leading end of the second arm portion in the -Y direction. It can be said that the three bosses 821, 822, and 823 are disposed, side by side, along an imaginary straight line orthogonal to the pivot axis R3.

The third link 83 is a substantially linear member linked with the second link 82 and the pressure release mechanism 67. The third link 83 includes a hole portion 831 formed on the first end side, and a hole portion 832 formed on the other end side. The boss 823 of the second link 82 pivotally fits in the hole portion 831. In addition, the boss 841 of the fourth link 84 pivotally fits in the hole portion 832. In the present embodiment, the third link 83 is longer than the first link 81.

As illustrated in FIG. 8, in a case where the rear opening/closing cover 22 is positioned at the closed position, the cover interlocking mechanism 8 positions the cam 672 at the pressing position. As illustrated in FIG. 9, in a case where the rear opening/closing cover 22 is positioned at the open position, the cover interlocking mechanism 8 positions the cam 672 at the pressure release position.

Specifically, in a case where the rear opening/closing cover 22 is positioned at the closed position as illustrated in FIG. 8, the first link 81, the second link 82, and the third link 83 of the cover interlocking mechanism 8 are folded in a Z shape. The range of the first link 81 from one end to the other end in the front-and-back direction overlaps, in the X-axis, with the range of the third link 83 from one end to the other end in the front-and-back direction. That is, in a case where the rear opening/closing cover 22 is positioned at the closed position, the cover interlocking mechanism 8 has a small occupied range in the front-and-back direction.

The position of the hole portion 832 of the third link 83 and the boss 841 of the fourth link 84, which are engaged with each other, is determined, depending on the position of the third link 83 positioned in a case where the rear opening/closing cover 22 is positioned at the closed position. Since the position of the boss 841 of the fourth link 84 is determined, the position of the cam shaft 671 and the cam 672 around the rotation axis Ax2 is determined. In this manner, in a case where the rear opening/closing cover 22 is positioned at the closed position, the cam 672 is positioned at the pressing position.

As described above, in a case where the cam 672 is positioned at the pressing position, the heating unit 61 is pushed against the pressing roller 62 by the urging force of the pressing spring 653, so that the nip portion np1 is pressed. That is, in a case where the rear opening/closing cover 22 is positioned at the closed position, the nip portion np1 is pressed so that the fixing apparatus 6 can fix an image.

If the rear opening/closing cover 22 is moved from the closed position to the open position, the first link 81 is pulled by the rear opening/closing cover 22 and moved toward the back side (i.e., the -X direction) in the front-and-back direction. With the movement of the first link 81, the second link 82 is pulled by the first link 81, and rotates clockwise in FIG. 9. With the rotation of the second link 82, the third link 83 is pushed out toward the front side (i.e., the +X direction) in the front-and-back direction. With the movement of the third link 83, the fourth link 84 is pressed; and rotates clockwise in FIG. 9, together with the cam shaft 671 and the cam 672. As a result, in accordance with the movement of the rear opening/closing cover 22 from the closed position to the open position, the cam 672 rotates clockwise in FIG. 9, from the pressing position to the pressure release position (FIG. 9).

As described above, in a case where the cam 672 is positioned at the pressure release position, the second cam surface 673b of the cam 672 pushes up the pressing arm 652 against the urging force of the pressing spring 653. With this operation, the pressure of the nip portion np1 is released. That is, in a case where the rear opening/closing cover 22 is positioned at the open position, the pressure of the nip portion np1 is released in the fixing apparatus 6, so that a user can more easily perform the jam handling.

While the rear opening/closing cover 22 is moved from the closed position to the open position, the first link 81, the second link 82, and the third link 83 of the cover interlocking mechanism 8 folded in a Z shape are unfolded. In a state illustrated in FIG. 9, the range of the first link 81 from one end to the other end in the front-and-back direction and the range of the third link 83 from one end to the other end in the front-and-back direction do not overlap with each other in the X axis. That is, the occupied range of the cover interlocking mechanism 8 in the front-and-back direction in a case where the rear opening/closing cover 22 is positioned at the open position is larger than the occupied range of the cover interlocking mechanism 8 in the front-and-back direction in a case where the rear opening/closing cover 22 is positioned at the closed position.

By the way, in a case where the rear opening/closing cover 22 is positioned at the closed position as illustrated in FIG. 8, the linking portion (812, 822) between the first link 81 and the second link 82 is positioned on the front side (i.e., the +X direction) with respect to the pivot axis R3 of the second link 82 in the front-and-back direction. In addition, in the case where the rear opening/closing cover 22 is positioned at the closed position, the linking portion (823, 831) between the second link 82 and the third link 83 is positioned on the back side (i.e., the -X direction) with respect to the pivot axis R3 of the second link 82 in the front-and-back direction.

In a case where the rear opening/closing cover 22 is positioned at the open position as illustrated in FIG. 9, the linking portion (812, 822) between the first link 81 and the second link 82 is positioned on the back side (i.e., the -X direction) with respect to the pivot axis R3 of the second link 82 in the front-and-back direction. In addition, in the case where the rear opening/closing cover 22 is positioned at the open position, the linking portion (823, 831) between the second link 82 and the third link 83 is positioned on the front side (i.e., the +X direction) with respect to the pivot axis R3 of the second link 82 in the front-and-back direction.

In this manner, in accordance with the opening/closing operation of the rear opening/closing cover 22, each of the linking portion between the first link 81 and the second link 82 and the linking portion between the second link 82 and the third link 83 moves from one side of the pivot axis R3 of the second link 82 to the other side in the front-and-back direction. In this configuration, the amount of rotation of the second link 82 performed in accordance with the opening/closing operation of the rear opening/closing cover 22 can be increased, so that the amount of movement of the third link 83 performed in accordance with the opening/closing operation of the rear opening/closing cover 22 can be increased. As a result, the changing mechanism 66 can more reliably apply and release the pressure in the fixing apparatus 6.

The cover interlocking mechanism 8 of the present embodiment interlocks the changing mechanism 66 with the rear opening/closing cover 22 so that the fixing apparatus 6 is in the pressing state (i.e., the first state) in a case where the rear opening/closing cover 22 is positioned at the closed position, and is in the pressure release state (i.e., the second state) in a case where the rear opening/closing cover 22 is positioned at the open position. Thus, the state of the fixing apparatus 6 can be changed between the pressing state where an image can be fixed, and the pressure release state where the jam handling can be performed, in accordance with the opening/closing operation of the rear opening/closing cover 22.

In addition, since the second link 82 is a pivot member, the movement of the first link 81 along the front-and-back direction is converted to the rotation of the second link 82, and the rotation of the second link 82 is converted to the movement of the third link 83 along the front-and-back direction. This configuration can advantageously reduce the amount of movement of each link of the cover interlocking mechanism 8 performed in the vertical direction. Thus, the image forming apparatus 1 can be downsized in the vertical direction. In addition, since the rear opening/closing cover 22 and the fixing apparatus 6 are collectively disposed in the back end portion, the cover interlocking mechanism 8 can also be downsized.

### Drum Shaft

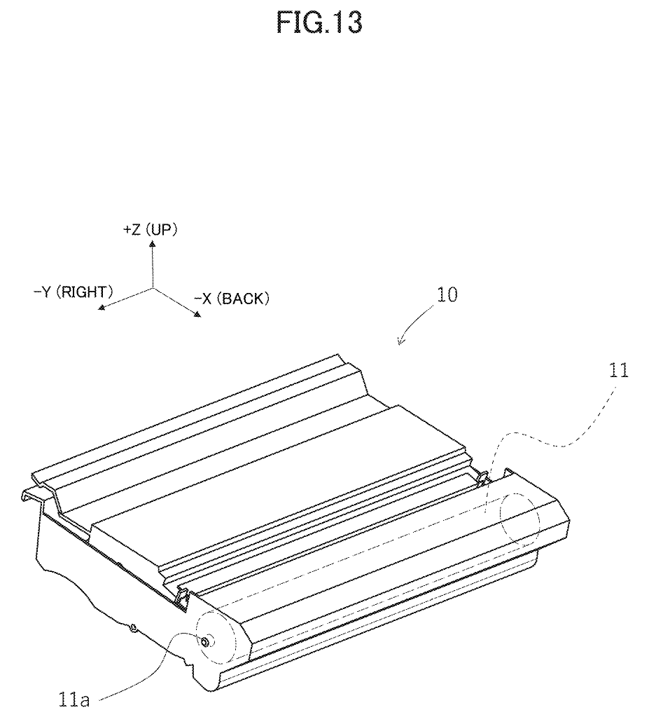

FIG. 13 is a perspective view of the process cartridge 10. As illustrated in FIG. 13, the photosensitive drum 11 includes a drum shaft 11a. The drum shaft 11a projects rightward (i.e., the -Y direction), or toward the first side plate 23 of the main body frame 2A, from the right end surface of the process cartridge 10.

The drum shaft 11a functions as an engaging portion that engages with the below-described shutter interlocking mechanism 9 in a case where the process cartridge 10 is attached to and detached from the main body frame 2A. Note that since the drum shaft 11a is one example of the engaging portion, a portion of the process cartridge 10 other than the drum shaft 11a may function as the engaging portion.

### First Side Plate

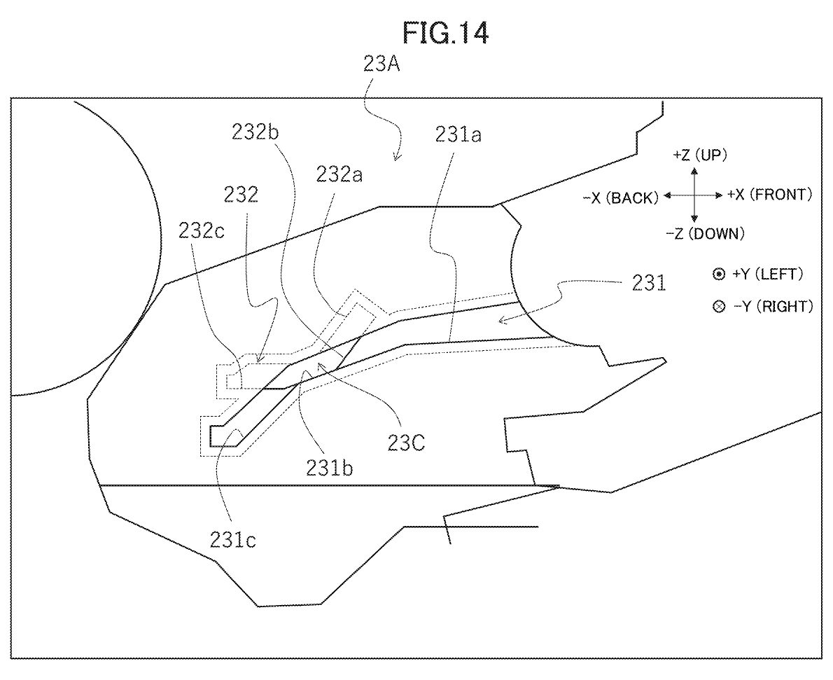

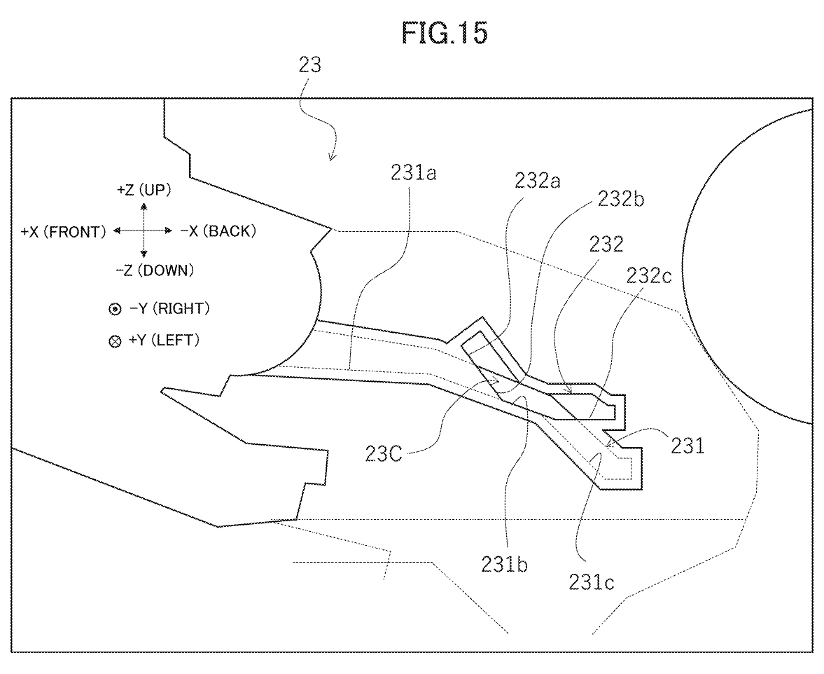

Next, the first side plate 23 of the main body frame 2A will be described with reference to FIGS. 1, 14, and 15. FIG. 1 is a diagram in which the first side plate 23 is viewed in a direction that extends rightward (i.e., the -Y direction) from the left side of the first side plate 23 (i.e., from a center side of the main body frame 2A). FIG. 14 is a diagram in which a portion of FIG. 1 is enlarged. FIG. 15 is a diagram in which a portion of the first side plate 23 is viewed in a direction that extends leftward (i.e., the +Y direction) from the right side of the first side plate 23 (i.e., from the outside of the main body frame 2A).

As illustrated in FIGS. 1 and 14, the first side plate 23 includes a front frame 23A and a back frame 23B. Each of the front frame 23A and the back frame 23B is a plate-shaped member that extends in directions that intersect the right-and-left direction. The front frame 23A forms a front-side portion of the first side plate 23, and the back frame 23B forms a back-side portion of the first side plate 23. The front frame 23A and the back frame 23B are joined or fastened to each other, so that the front frame 23A and the back frame 23B form the first side plate 23 that is continuous in the front-and-back direction. Note that the first side plate 23 may be a single plate-shaped member in which a portion that corresponds to the front frame 23A and a portion that corresponds to the back frame 23B are, for example, formed integrally with each other.

As illustrated in FIG. 1, a cartridge rail 231 and an abutment piece rail 232 are formed in the front frame 23A. The cartridge rail 231 is formed in the left side-surface (FIG. 14) of the front frame 23A, and the abutment piece rail 232 is formed in the right side-surface of the front frame 23A.

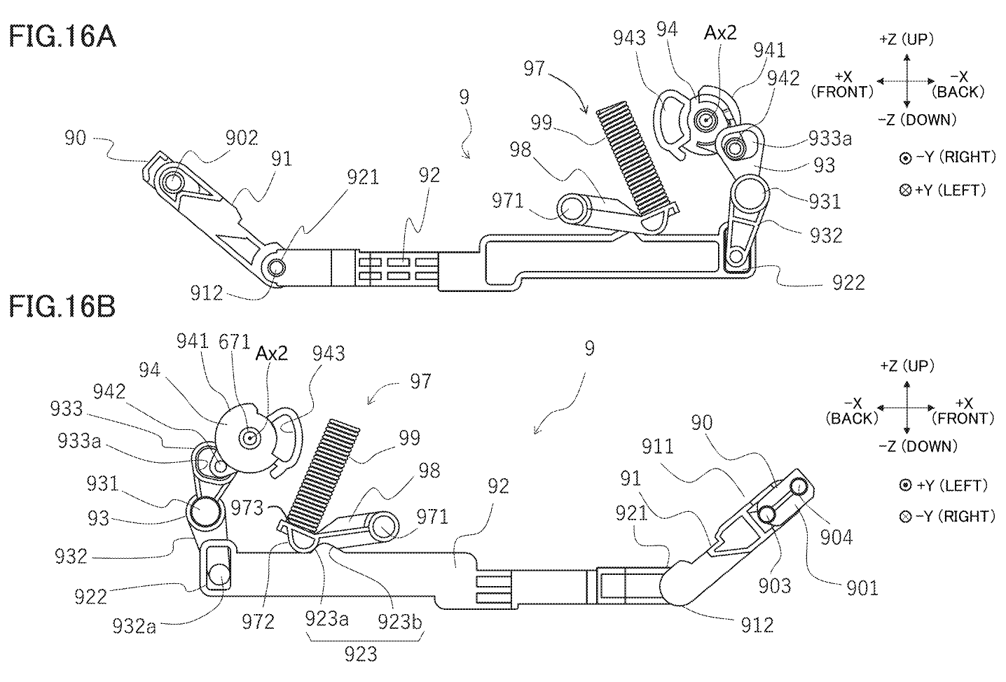

The cartridge rail 231 is a guide portion that guides the drum shaft 11a (FIG. 13) of the photosensitive drum 11. The abutment piece rail 232 is a guide portion that guides an abutment piece 90 (FIGS. 16A and 16B) of the below-described shutter interlocking mechanism 9.

As illustrated in FIG. 14, the cartridge rail 231 is a groove portion that is opened toward the left side, and that extends in a direction that intersects the right-and-left direction. When viewed in the right-and-left direction, the cartridge rail 231 of the present embodiment is opened toward the front side and inclined downward toward the back side. The angle of inclination of the cartridge rail 231 with respect to the horizontal direction may not be constant, and the cartridge rail 231 may be bent as illustrated in FIGS. 1 and 14.

The cartridge rail 231 takes in the drum shaft 11a (FIG. 13) of the photosensitive drum 11, and guides the drum shaft 11a in a case where the process cartridge 10 is attached to and detached from the apparatus body 2. The process cartridge 10 is attached to the apparatus body 2 from the front side toward the back side, and detached from the apparatus body 2 from the back side toward the front side. Thus, in a case where the process cartridge 10 is attached to and detached from the apparatus body 2, the drum shaft 11a is guided by the cartridge rail 231 of the first side plate 23 (i.e., the front frame 23A).

As illustrated in FIG. 15, the abutment piece rail 232 is a groove portion that is opened toward the right side, and that extends in a direction that intersects the right-and-left direction. When viewed in the right-and-left direction, the abutment piece rail 232 of the present embodiment is opened toward the front side and inclined downward toward the back side.

The cartridge rail 231 includes a front portion 231a, a middle portion 231b, and a back portion 231c. The abutment piece rail 232 also includes a front portion 232a, a middle portion 232b, and a back portion 232c. The middle portion 231b of the cartridge rail 231 and the middle portion 232b of the abutment piece rail 232 overlap with each other when viewed in the right-and-left direction, and communicate with each other. In the middle portion 231b of the cartridge rail 231 and the middle portion 232b of the abutment piece rail 232, a through-hole 23C that passes through the front frame 23A in the right-and-left direction is formed.

That is, the through-hole 23C is a portion in which the middle portion 231b of the cartridge rail 231 and the middle portion 232b of the abutment piece rail 232 overlap with each other. The overlap allows the cartridge rail 231 and the abutment piece rail 232 to be formed as a single member.

If viewed from the outside (i.e., the right side) of the first side plate 23, the drum shaft 11a is exposed through the through-hole 23C when the drum shaft 11a passes the middle portion 231b of the cartridge rail 231 in a case where the process cartridge 10 is attached to and detached from the apparatus body 2.

In addition, the front portion 232a of the abutment piece rail 232 extends above the front portion 231a of the cartridge rail 231. The back portion 232c of the abutment piece rail 232 extends above the back portion 231c of the cartridge rail 231. That is, each of the front-side end portion and the back-side end portion of the abutment piece rail 232 is positioned above the cartridge rail 231. In addition, the length of the abutment piece rail 232 in the front-and-back direction is shorter than the length of the cartridge rail 231 in the front-and-back direction.

### Shutter Interlocking Mechanism

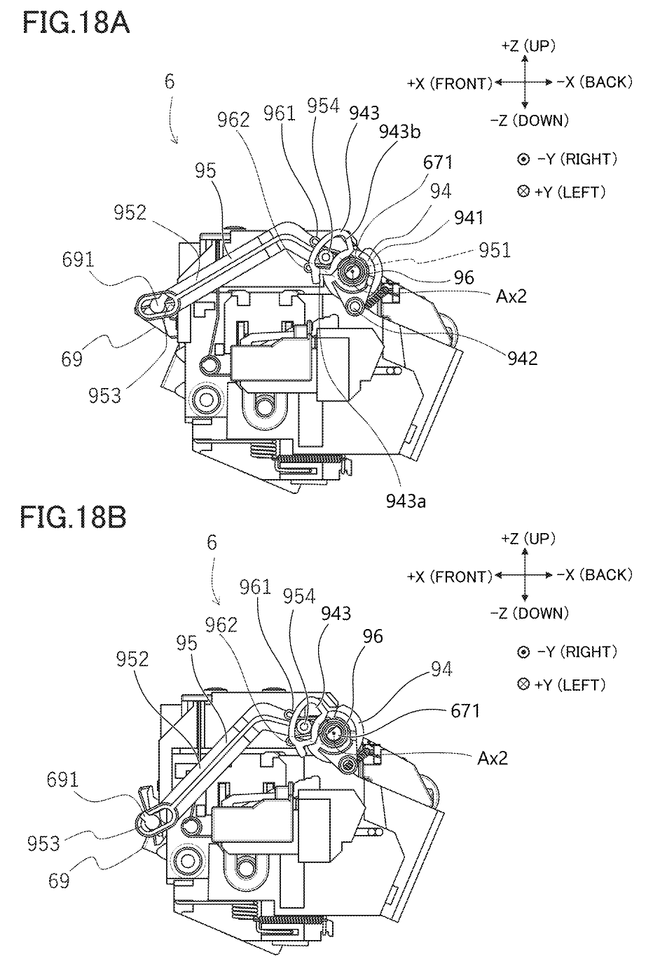

Next, the shutter interlocking mechanism 9 will be described with reference to FIG. 1 and FIGS. 16A to 18B. FIG. 16A is a diagram illustrating the shutter interlocking mechanism 9 viewed, as in FIG. 15, in a direction (i.e., the +Y direction) that extends from the outside toward the center side in the right-and-left direction. FIG. 16B is a diagram illustrating the shutter interlocking mechanism 9 viewed in a direction (i.e., the -Y direction) that extends from the center side toward the outside in the right-and-left direction. Each of FIGS. 17A and 17B is a perspective view illustrating the fixing apparatus 6 and a portion of the shutter interlocking mechanism 9. Each of FIGS. 18A and 18B is a diagram in which the fixing apparatus 6 and a portion of the shutter interlocking mechanism 9 are viewed in the right-and-left direction. Each of FIGS. 17A and 18A corresponds to a state where the process cartridge 10 is attached to the apparatus body 2. Each of FIGS. 17B and 18B corresponds to a state where the process cartridge 10 is detached from the apparatus body 2.

As illustrated in FIG. 1 and FIGS. 16A and 16B, the apparatus body 2 includes the shutter interlocking mechanism 9. The shutter interlocking mechanism 9 has a function that opens and closes the shutter 69 in accordance with the attachment and detachment of the process cartridge 10. Specifically, the shutter interlocking mechanism 9 interlocks the attachment-and-detachment operation of the process cartridge 10 and the shutter 69 with each other so that the shutter 69 is positioned at an opening position in a state where the process cartridge 10 is attached to the main body frame 2A, and that the shutter 69 is positioned at a shielding position in a state where the process cartridge 10 is not attached to the main body frame 2A.

The shutter interlocking mechanism 9 is positioned on a side opposite to the process cartridge 10 with respect to the front frame 23A of the first side plate 23 (that is, on the right side with respect to the front frame 23A).

As illustrated in FIG. 1 and FIGS. 16A and 16B, the shutter interlocking mechanism 9 includes the abutment piece 90, a first pivot link 91, a linear-motion link 92, a second pivot link 93, and a third pivot link 94. In addition, as illustrated in FIGS. 17A to 18B, the shutter interlocking mechanism 9 includes a shutter link 95 and a coil spring 96.

The shutter link 95 is an arm member engaged with the shutter 69. The shutter link 95 pivots independently from the cam 672 of the above-described changing mechanism 66, around the rotation axis Ax2 (i.e., the second rotation axis), and thereby rotates the shutter 69 between the shielding position and the opening position. The third pivot link 94 rotates around the rotation axis Ax2 (i.e., the second rotation axis) shared by the cam 672 and the shutter link 95, and thereby rotates the shutter link 95. For rotating the third pivot link 94, the linear-motion link 92 can move in a direction (i.e., the +X direction) that extends from the back end portion 2B (i.e., the first end portion) toward the front end portion 2F (i.e., the second end portion) of the main body frame 2A, and in a direction (i.e., the -X direction) opposite to the direction (i.e., the +X direction). The abutment piece 90 is an engaged portion that can engage with the drum shaft 11a (i.e., an engaging portion) of the process cartridge 10.

In a process where the process cartridge 10 is attached to the main body frame 2A, the abutment piece 90 (i.e., an engaged portion) engages with the drum shaft 11a (i.e., an engaging portion) of the process cartridge 10. By the force that the abutment piece 90 (i.e., an engaged portion) receives from the drum shaft 11a (i.e., an engaging portion), the linear-motion link 92 is moved in the -X direction that extends from the front end portion 2F (i.e., the second end portion) toward the back end portion 2B (i.e., the first end portion) of the main body frame 2A. The shutter link 95 is rotated by the movement of the linear-motion link 92. In addition, the shutter 69 is rotated from the shielding position to the opening position by the rotation of the shutter link 95.

Hereinafter, components of the shutter interlocking mechanism 9 will be specifically described. As illustrated in FIGS. 16A and 16B, the abutment piece 90 is a component that moves in contact with a portion of the process cartridge 10. The abutment piece 90 of the present embodiment contacts the drum shaft 11a of the photosensitive drum 11. The abutment piece 90 is slidably engaged with the abutment piece rail 232. The abutment piece rail 232 guides the abutment piece 90 that moves in contact with the drum shaft 11a.

The abutment piece 90 includes a main-body portion 901, a linking portion 902, a first projection 903, and a second projection 904. The main-body portion 901 is a plate-shaped member, and the thickness direction of the main-body portion 901 extends in the right-and-left direction. The linking portion 902 is a projection portion (i.e., a boss) that projects from the right side of the main-body portion 901 toward the right direction. Each of the first projection 903 and the second projection 904 is a projection portion (i.e., a pin) that projects from the left side of the main-body portion 901 toward the left direction. Both of the first projection 903 and the second projection 904 are engaged with the abutment piece rail 232 of the first side plate 23, and are guided by the abutment piece rail 232.

The second projection 904 is positioned downstream of the first projection 903 in the attachment direction of the process cartridge 10. The attachment direction of the process cartridge 10 is a direction in which the process cartridge 10 is moved along the cartridge rail 231 when attached to the apparatus body 2. The attachment direction of the process cartridge 10 in the present embodiment is a direction that extends toward the back side (i.e., the -X direction) in the front-and-back direction, and that is inclined downward.

The abutment piece 90 is positioned on a side opposite to the process cartridge 10 with respect to the front frame 23A of the first side plate 23 (that is, on the right side with respect to the front frame 23A). Each of the first projection 903 and the second projection 904 is positioned so as not to project toward the process cartridge 10 side (i.e., the left side) with respect to the front frame 23A of the first side plate 23.

The first projection 903 contacts the drum shaft 11a when the process cartridge 10 is attached to the apparatus body 2. The second projection 904 contacts the drum shaft 11a when the process cartridge 10 is detached from the apparatus body 2. That is, the first projection 903 contacts the drum shaft 11a of the process cartridge 10 to be attached to the apparatus body 2, and the second projection 904 contacts the drum shaft 11a of the process cartridge 10 to be detached from the apparatus body 2.

The first projection 903 contacts the drum shaft 11a of the process cartridge 10 via the through-hole 23C, in the middle portion 232b (i.e., the through-hole 23C) of the abutment piece rail 232. In addition, the second projection 904 contacts the drum shaft 11a of the process cartridge 10 via the through-hole 23C, in the middle portion 232b (i.e., the through-hole 23C) of the abutment piece rail 232.

The drum shaft 11a may contact the first projection 903 and the second projection 904 in the through-hole 23C, or may contact the first projection 903 and the second projection 904 at a position positioned on the right side of the through-hole 23C in the right-and-left direction.

The first pivot link 91 is a linear member linked with the abutment piece 90, and is positioned on the right side of the front frame 23A of the first side plate 23 in the right-and-left direction. The front end portion of the first pivot link 91 has a fitting portion 911 in which the linking portion 902 of the abutment piece 90 fits, and the back end portion of the first pivot link 91 has a boss 912 that projects leftward. The first pivot link 91 is inclined such that the fitting portion 911 is positioned above and in front of the boss 912. The linking portion 902 fits in the fitting portion 911, so that the first pivot link 91 is linked with the abutment piece 90 and moves in accordance with the movement of the abutment piece 90.

The linear-motion link 92 is a linear member that is linked with the first pivot link 91, and that extends in the front-and-back direction. The linear-motion link 92 is positioned on the right side of the front frame 23A of the first side plate 23 in the right-and-left direction. The front end portion of the linear-motion link 92 has a fitting portion 921 in which the boss 912 of the first pivot link 91 fits, and the back end portion of the linear-motion link 92 has a linking hole 922. The boss 912 fits in the fitting portion 921, so that the linear-motion link 92 is linked with the first pivot link 91 and moves linearly in the front-and-back direction, in accordance with the pivot of the first pivot link 91.

The second pivot link 93 is linked with the linear-motion link 92, and is supported by the first side plate 23. The second pivot link 93 includes a support portion 931 that is pivotally supported by the first side plate 23, a first arm 932 that extends downward from the support portion 931, and a second arm 933 that extends upward from the support portion 931. The leading end of the first arm 932 has an engaging pin 932a that projects leftward, and the leading end of the second arm 933 has a linking hole 933a.

The engaging pin 932a of the first arm 932 engages with the linking hole 922 of the linear-motion link 92, from the right side. In a case where the linear-motion link 92 moves in the front-and-back direction, the engaging pin 932a is moved while pressed by the inner wall of the linking hole 922. The second pivot link 93 is linked with the linear-motion link 92 via the engagement between the engaging pin 932a and the linking hole 922, and pivots around the support portion 931 in accordance with the movement of the linear-motion link 92.

The third pivot link 94 is linked with the second pivot link 93, and pivotally supported by the cam shaft 671 of the fixing apparatus 6. The third pivot link 94 can pivot around the rotation axis Ax2, independently from the cam shaft 671. That is, the third pivot link can pivot, independently from the above-described pressure release mechanism 67. In addition, the shutter interlocking mechanism 9 can operate, independently from the cover interlocking mechanism 8 and the changing mechanism 66.

The third pivot link 94 includes a support portion 941, an engaging pin 942, and a linking hole 943. The support portion 941 is pivotally supported by the cam shaft 671. The engaging pin 942 extends from the support portion 941. The linking hole 943 is formed at a phase in the rotational direction around the support portion 941, different from the phase of the engaging pin 942. The engaging pin 942 projects rightward in the right-and-left direction (i.e., the second direction). The engaging pin 942 engages with the linking hole 933a that is a hole of the second pivot link 93, from the left side. When the second pivot link 93 pivots, the engaging pin 942 is pressed by the inner wall of the linking hole 933a. The third pivot link 94 is linked with the second pivot link 93 via the engagement between the engaging pin 942 and the linking hole 933a, and pivots around the cam shaft 671 in accordance with the pivot of the second pivot link 93.

As illustrated in FIGS. 17A to 18B, the shutter link 95 is linked with the third pivot link 94, and is pivotally supported by the cam shaft 671 of the fixing apparatus 6. The shutter link 95 can pivot around the rotation axis Ax2, independently from the cam shaft 671. That is, the third pivot link 94 is pivotally supported without being affected by the above-described changing mechanism 66. The shutter link 95 is moved in accordance with the movement of the third pivot link 94, and moves the shutter 69 of the fixing apparatus 6 between a shielding position and an opening position. The shutter link 95 is positioned at the right end portion of the fixing apparatus 6.

The shutter link 95 includes a support portion 951, an arm portion 952, an engaging portion 953, and an engaging pin 954.

The support portion 951 of the shutter link 95 is pivotally supported by the cam shaft 671. Note that the cam shaft 671 includes a projection portion 671a that projects rightward from the right end portion of the upper frame 64 (FIGS. 17A and 17B). The support portion 951 is supported by the projection portion 671a of the cam shaft 671. The arm portion 952 extends frontward from the support portion 951. The engaging portion 953 is positioned at the front end portion of the arm portion 952, and includes an engaging hole 953a formed in an elliptical hole elongated in the front-and-back direction. The engaging hole 953a is engaged with an opening/closing pin 691 that projects rightward from the right end portion of the shutter 69.

The shutter link 95 can pivot in a direction in which the engaging portion 953 moves vertically around the support portion 951. In a case where the engaging portion 953 moves downward, the shutter 69 is moved from the opening position (FIGS. 17A and 18A) to the shielding position (FIGS. 17B and 18B). In a case where the engaging portion 953 moves upward, the shutter 69 is moved from the shielding position to the opening position.

The engaging pin 954 of the shutter link 95 projects rightward from the back portion of the arm portion 952. The engaging pin 954 engages with the linking hole 943 of the third pivot link 94, from the left side.

The coil spring 96 is a torsion spring attached to the support portion 941 of the third pivot link 94. The coil spring 96 includes a first arm portion 961 and a second arm portion 962. The first arm portion 961 extends from the inner diameter side toward the outer diameter side of the linking hole 943, so as to overlap with the linking hole 943. Similarly, the second arm portion 962 extends from a position different from the position of the first arm portion 961 in the circumferential direction, in a direction from the inner diameter side toward the outer diameter side of the linking hole 943, so as to overlap with the linking hole 943.

The first arm portion 961 is positioned above the engaging pin 954 in the linking hole 943, and the second arm portion 962 is positioned below the engaging pin 954 in the linking hole 943. The coil spring 96 pivots in accordance with the pivot of the third pivot link 94. If the third pivot link 94 pivots, the first arm portion 961 or the second arm portion 962 engages with the engaging pin 954. The shutter link 95 is linked with the third pivot link 94 via the engagement between the engaging pin 954 and the first arm portion 961 or the second arm portion 962. Thus, the shutter link 95 is moved in accordance with the pivot of the third pivot link 94, and moves the shutter 69 between the shielding position and the opening position.

Note that the coil spring 96 may be disposed such that the engaging pin 954 is interposed between the first arm portion 961 and a first edge 943a of the linking hole 943. In this case, when the third pivot link 94 pivots counterclockwise in FIGS. 18A and 18B, the first arm portion 961 of the coil spring 96 presses the engaging pin 954 downward in FIGS. 18A and 18B. In addition, when the third pivot link 94 pivots clockwise in FIGS. 18A and 18B, the first edge 943a of the linking hole 943 presses the engaging pin 954 upward in FIGS. 18A and 18B.

In the present embodiment, in a case where the process cartridge 10 is attached to or detached from the apparatus body 2, the abutment piece 90 (i.e., an engaged portion) of the shutter interlocking mechanism 9 engages with the drum shaft 11a (i.e., an engaging portion) of the process cartridge 10, and moves along the abutment piece rail 232. The movement of the abutment piece 90 is transmitted to the shutter 69 via the first pivot link 91, the linear-motion link 92, the second pivot link 93, the third pivot link 94, and the shutter link 95, so that the shutter 69 is moved between the shielding position and the opening position.

The shutter interlocking mechanism 9 of the present embodiment includes the abutment piece 90, the first pivot link 91, the linear-motion link 92, the second pivot link 93, the third pivot link 94, the shutter link 95, and the coil spring 96. However, the present disclosure is not limited to this. For example, the shutter interlocking mechanism 9 may be constituted by a single link that is linked with the shutter 69, and that opens and closes the shutter 69 when contacting the process cartridge 10. In addition, the type of movement (i.e., a mode such as pivot or linear motion, and the direction of the movement) of each link member that constitutes the shutter interlocking mechanism 9 is not limited to the type described in the present embodiment. The type of movement of each link member may be any type of movement as long as the movement properly opens and closes the shutter 69 in accordance with the insertion and removal of the process cartridge 10.

Note that in the present embodiment, the force is transmitted from the third pivot link 94 to the shutter link 95 via the coil spring 96. In this configuration, in a case where a user tries to detach the process cartridge 10 from the apparatus body 2 in a state where a jammed sheet is left, for example, in the inlet 6i of the fixing apparatus 6, it can be advantageously prevented that the removal of the process cartridge 10 becomes difficult, and that the shutter interlocking mechanism 9 is damaged. That is, in accordance with the removal of the process cartridge 10, the force is transmitted in the order of the abutment piece 90, the first pivot link 91, the linear-motion link 92, the second pivot link 93, and the third pivot link 94, and the third pivot link 94 tries to pivot counterclockwise, from the position illustrated in FIG. 18A. In this case, if the movement of the shutter 69 from the opening position to the shielding position (FIG. 18B) is prevented by the jammed sheet, the pivot of the shutter link 95 is also prevented, so that the engaging pin 954 cannot move from the position illustrated in FIG. 18A to the position illustrated in FIG. 18B. However, since the coil spring 96 deforms elastically, the first arm portion 961 is allowed to move relative to the third pivot link 94 so as to approach the second edge 943b of the linking hole 943. Thus, even in a state where the shutter 69 and the shutter link 95 do not move, the third pivot link 94 can be moved to a position (FIG. 18B) that allows the process cartridge 10 to be removed.

That is, even in a case where the shutter 69 cannot be moved from the opening position to the shielding position, the coil spring 96 allows the pivot of the third pivot link 94 and the movement of the abutment piece 90, which moves together with the third pivot link 94. Thus, it can be prevented that the process cartridge 10 cannot be removed because the movement of the abutment piece 90 is stopped before the second projection 904 of the abutment piece 90 enters the front portion 232a from the middle portion 232b (i.e., the through-hole 23C) of the abutment piece rail 232. In addition, it can be prevented that the shutter interlocking mechanism 9 is damaged because a user who is prevented from removing the process cartridge 10 pulls the process cartridge 10 hard.

### Lock Mechanism

As illustrated in FIGS. 16A and 16B, the apparatus body 2 includes a lock mechanism 97 that controls the movement of the shutter interlocking mechanism 9. Specifically, the lock mechanism 97 can control the movement of the linear-motion link 92 in the front-and-back direction, by holding the linear-motion link 92.

The lock mechanism 97 includes an arm 98 that contacts the top surface of the linear-motion link 92, and a lock spring 99 that pushes the leading end of the arm 98 against the top surface of the linear-motion link 92. The lock spring 99 is one example of an urging member that pushes the leading end of the arm 98 against the linear-motion link 92.

The arm 98 includes a support portion 971 that is pivotally supported by the first side plate 23, an abutment portion 972 that contacts the top surface of the linear-motion link 92, and a spring receiving portion 973 that receives the lock spring 99. The arm 98 extends from the support portion 971 that is the base end, toward the abutment portion 972 that is the leading end, in a direction (that is substantially the front-and-back direction) that intersects the right-and-left direction. At the front end portion of the arm 98, the abutment portion 972 is positioned. The arm 98 can pivot around an axis that extends in the right-and-left direction. The abutment portion 972 can move around the support portion 971 in the vertical direction. The spring receiving portion 973 is positioned above the abutment portion 972.

The upper end portion of the lock spring 99 is supported by the first side plate 23, and the lower end portion of the lock spring 99 is attached to the spring receiving portion 973 of the arm 98. The lock spring 99 urges the arm 98 such that the abutment portion 972 of the arm 98 is pushed against the top surface of the linear-motion link 92.

On the top surface of the linear-motion link 92, a link projection 923 that projects toward the lock mechanism 97 side (i.e., the upper side) is formed between the fitting portion 921 and the linking hole 922. The link projection 923 has a shape of a projection that includes a first sloped surface 923a and a second sloped surface 923b. The first sloped surface 923a is inclined downward toward the back side. The second sloped surface 923b is formed continuously with the first sloped surface 923b, in front of the first sloped surface 923a; and is inclined downward toward the front side.

In a case where the linear-motion link 92 moves in the front-and-back direction, the abutment portion 972 of the arm 98 moves so as to climb over the link projection 923 against the urging force of the lock spring 99. The abutment portion 972 of the arm 98 can stably be positioned on the back side of the first sloped surface 923a of the link projection 923, or on the front side of the second sloped surface 923b of the link projection 923.

In a case where the abutment portion 972 of the arm 98 is positioned on the back side of the link projection 923, the abutment portion 972 locks the first sloped surface 923a, so that the linear-motion link 92 is restricted from moving backward. In a case where the abutment portion 972 of the arm 98 is positioned on the front side of the link projection 923, the abutment portion 972 locks the second sloped surface 923b, so that the linear-motion link 92 is restricted from moving frontward.

That is, the lock mechanism 97 can restrict the movement of the shutter interlocking mechanism 9 by causing the arm 98 to contact the linear-motion link 92 on the back side of the link projection 923 and restrict the linear-motion link 92 from moving backward. In addition, the lock mechanism 97 can restrict the movement of the shutter interlocking mechanism 9 by causing the arm 98 to contact the linear-motion link 92 on the front side of the link projection 923 and restrict the linear-motion link 92 from moving frontward. The lock mechanism 97 can restrict the shutter 69 from being unintentionally opened and closed in a state where the attachment and detachment of the process cartridge 10 is not being performed. In this manner, the lock mechanism 97 restricts the movement of the linear-motion link 92 by causing the arm 98 to hold the linear-motion link 92. Thus, the lock mechanism 97 can be achieved in a simple configuration.

The specific configuration of the lock mechanism 97 is not limited to the configuration described in the present embodiment. For example, the lock mechanism 97 that is a member other than the shutter interlocking mechanism 9 may not be disposed. In this case, a link member itself that constitutes the shutter interlocking mechanism 9 may have a function that holds the shutter 69 at the opening position or the shielding position.

### Positional Relationship between Changing Mechanism, Cover Interlocking Mechanism, and Shutter Interlocking Mechanism

As described above, the apparatus body 2 of the image forming apparatus 1 of the present embodiment includes the changing mechanism 66, the cover interlocking mechanism 8, and the shutter interlocking mechanism 9. As described above, both of the cover interlocking mechanism 8 and the shutter interlocking mechanism 9 are disposed on the right-side end portion 2R side (i.e., the third end portion side) of the main body frame 2A, as illustrated in FIG. 1, in the right-and-left direction (i.e., the second direction).

That is, the cover interlocking mechanism 8 and the shutter interlocking mechanism 9 are collectively disposed on the right-side end portion 2R side (i.e., the third end portion side) of the main body frame 2A. In this configuration, the apparatus body 2 can be downsized in the right-and-left direction (i.e., the second direction), in the image forming apparatus 1 that has a function for changing the pressure of the nip portion np1 in accordance with the opening/closing operation of the rear opening/closing cover 22, and a function for opening and closing the shutter 69 of the fixing apparatus 6 in accordance with the attachment-and-detachment operation of the process cartridge 10.

Each of the cover interlocking mechanism 8 and the shutter interlocking mechanism 9 is disposed in an end portion of the main body frame 2A in the right-and-left direction, so as not to interfere with the process cartridge 10, the fixing apparatus 6, and conveyance rollers and conveyance guides and the like of the sheet conveyance path P. If the shutter interlocking mechanism 9 is disposed on the left-side end portion 2L side of the main body frame 2A while the cover interlocking mechanism 8 is disposed on the right-side end portion 2R side of the main body frame 2A, the apparatus body 2 is upsized in the right-and-left direction (i.e., the second direction). In the present embodiment, however, since the cover interlocking mechanism 8 and the shutter interlocking mechanism 9 are collectively disposed on the right-side end portion 2R side (i.e., the third end portion side) of the main body frame 2A, the apparatus body 2 can be prevented from being upsized in the right-and-left direction (i.e., the second direction).

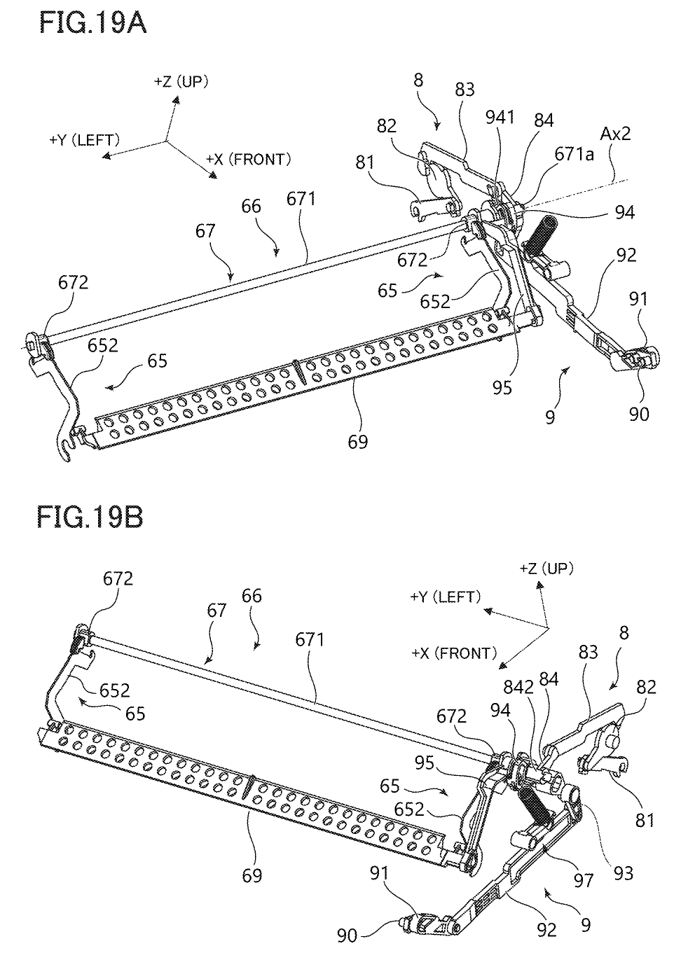

The positional relationship between the changing mechanism 66, the cover interlocking mechanism 8, and the shutter interlocking mechanism 9 will be further described with reference to FIGS. 19A to 21B.

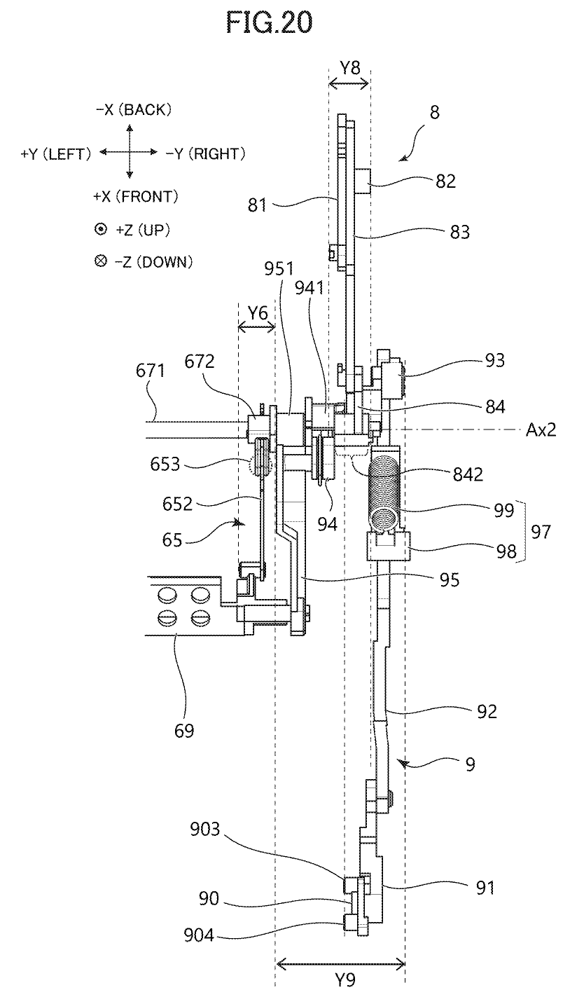

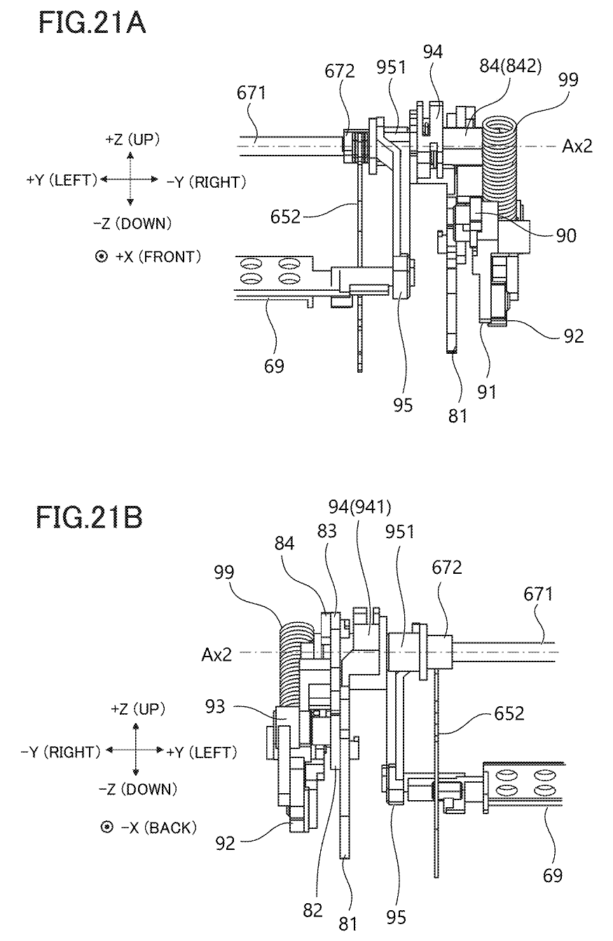

Each of FIGS. 19A and 19B is a perspective view of the changing mechanism 66, the cover interlocking mechanism 8, and the shutter interlocking mechanism 9. FIG. 20 is a top view in which a portion of the changing mechanism 66, the cover interlocking mechanism 8, and the shutter interlocking mechanism 9 are viewed from above toward the gravity direction. FIG. 21A is a diagram in which a portion of the changing mechanism 66, the cover interlocking mechanism 8, and the shutter interlocking mechanism 9 are viewed from the back end portion 2B side of the main body frame 2A toward the front side (i.e., the +X direction). FIG. 21B is a diagram in which a portion of the changing mechanism 66, the cover interlocking mechanism 8, and the shutter interlocking mechanism 9 are viewed from the front end portion 2F side of the main body frame 2A toward the back side (i.e., the -X direction).

As illustrated in FIGS. 19A, 19B and 20, the cover interlocking mechanism 8 is disposed at a position different from the position of the changing mechanism 66 in the right-and-left direction (i.e., the second direction). That is, in the right-and-left direction (i.e., the second direction), a range Y8 in which the links (81, 82, 83, and 84) that constitute the cover interlocking mechanism 8 are disposed is different from a range Y6 in which the pressing arm 652, the pressing spring 653 (i.e., an urging member), and the cam 672 of the changing mechanism 66 are disposed. In this configuration, the cover interlocking mechanism 8 and the changing mechanism 66 can be disposed without interfering with each other in the right-and-left direction (i.e., the second direction).

In addition, as illustrated in FIGS. 19A to 21B, the shutter interlocking mechanism 9 is disposed at a position different from the position of the changing mechanism 66 in the right-and-left direction (i.e., the second direction). That is, in the right-and-left direction (i.e., the second direction), a range Y9 in which the elements (90 to 95) that constitute the shutter interlocking mechanism 9 are disposed is different from the range Y6 in which the pressing arm 652, the pressing spring 653 (i.e., an urging member), and the cam 672 of the changing mechanism 66 are disposed. In this configuration, the shutter interlocking mechanism 9 and the changing mechanism 66 can be disposed without interfering with each other in the right-and-left direction (i.e., the second direction).

In addition, as illustrated in FIGS. 19A to 21B, the fourth link 84 of the cover interlocking mechanism 8 is disposed on the outside with respect to the shutter link 95 of the shutter interlocking mechanism 9 in the right-and-left direction (i.e., the second direction). In this configuration, the fourth link 84 of the cover interlocking mechanism 8 and the shutter link 95 of the shutter interlocking mechanism 9 can be disposed without interfering with each other in the right-and-left direction (i.e., the second direction).

In particular, in the present embodiment, both of the fourth link 84 and the shutter link 95 are members that can rotate independently from each other, around the rotation axis Ax2 (i.e., the second rotation axis). As described above, the fourth link 84 and the shutter link 95, which rotates around the common rotation axis Ax2 (i.e., the second rotation axis), are disposed, shifted from each other in the right-and-left direction (i.e., the second direction). As a result, the cover interlocking mechanism 8 and the shutter interlocking mechanism 9 can be disposed easily.

In addition, as illustrated in FIGS. 19A to 21B, the fourth link 84 of the cover interlocking mechanism 8 is disposed on the inside with respect to the linear-motion link 92 of the shutter interlocking mechanism 9 in the right-and-left direction (i.e., the second direction). As a result, the linear-motion link 92 can be disposed as outside as possible.

As illustrated in FIGS. 20 to 21B, the position of the fourth link 84 in the right-and-left direction (i.e., the second direction) overlaps with the position of the abutment piece 90 (i.e., an engaged portion) of the shutter interlocking mechanism 9 in the right-and-left direction (i.e., the second direction). In other words, when viewed in at least one direction orthogonal to the right-and-left direction, the fourth link 84 overlaps with the abutment piece 90. As a result, the apparatus can be made smaller in the right-and-left direction than the apparatus in which the position of the abutment piece 90 (i.e., an engaged portion) and the position of the fourth link 84 are separated from each other in the right-and-left direction (i.e., the second direction). In addition, since the linear-motion link 92 that does not directly engage with the process cartridge 10 is positioned on the outside with respect to the fourth link 84 in the right-and-left direction (i.e., the second direction), the linear-motion link 92 can be prevented from contacting the process cartridge 10.

As described above, in the right-and-left direction (i.e., the second direction), a portion of the shutter interlocking mechanism 9 is positioned on the inside with respect to the fourth link 84, and another portion of the shutter interlocking mechanism 9 is positioned on the outside with respect to the fourth link 84. In this case, the shutter interlocking mechanism 9 includes a portion that overlaps with the fourth link 84 when viewed in a direction orthogonal to the right-and-left direction (i.e., the second direction), and that can transmit force from the outside with respect to the fourth link 84 to the inside with respect to the fourth link 84.

In the present embodiment, the support portion 941 of the third pivot link 94 of the shutter interlocking mechanism 9 is positioned on the inside with respect to the fourth link 84 in the right-and-left direction (i.e., the second direction). In addition, the support portion 931 of the second pivot link 93 is positioned on the outside with respect to the fourth link 84 in the right-and-left direction (i.e., the second direction) (FIG. 21A). In addition, the third pivot link 94 includes the engaging pin 942 that serves as a linked portion, and the second pivot link 93 includes the linking hole 933a that serves as a linking portion that is linked with the engaging pin 942.

In addition, at least one of the linking hole 933a (i.e., a linking portion) and the engaging pin 942 (i.e., a linked portion) overlaps with the fourth link 84 when viewed in at least one direction orthogonal to the right-and-left direction. Thus, the linking hole 933a and the engaging pin 942 of the shutter interlocking mechanism 9 function as the portion that can transmit force from the outside with respect to the fourth link 84 to the inside with respect to the fourth link 84 in the right-and-left direction (i.e., the second direction). Note that the linking hole may be formed in the third pivot link 94, and that the engaging pin that engages with the linking hole may be disposed in the second pivot link 93.

Note that the support portion 842 of the fourth link 84 and the support portion 951 of the shutter link 95 may overlap with each other when viewed in the right-and-left direction (i.e., the second direction). In addition, the support portion 842 of the fourth link 84 and the support portion 941 of the third pivot link 94 may overlap with each other when viewed in the right-and-left direction (i.e., the second direction).

Note that in the present embodiment, the third pivot link 94 (i.e., a pivot link) of the shutter interlocking mechanism 9 and the shutter link 95 are disposed coaxially with the cam 672 of the changing mechanism 66, and supported rotatably independent from the cam 672. Thus, the apparatus that includes the shutter interlocking mechanism 9 and the changing mechanism 66 can be made smaller than the apparatus in which at least one of the third pivot link 94 and the shutter link 95 is disposed on an axis different from the rotation axis Ax2 of the cam 672.

The present disclosure can provide a new image forming apparatus in which the conventional technology has been improved.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-224570, filed December 19, 2024, which is hereby incorporated by reference herein in its entirety.

What is claimed is:

1. An image forming apparatus comprising:
a main body frame including a first end portion on a first end side in a first direction that is a horizontal direction, a second end portion on a second end side opposite to the first end side in the first direction, a third end portion on a third end side in a second direction that is a horizontal direction and that is orthogonal to the first direction, and a fourth end portion on a fourth end side opposite to the third end side in the second direction;
a fixing unit disposed on the first end side of the main body frame in the first direction, the fixing unit including a heating unit and a pressing roller both configured to form a nip portion, the fixing unit being configured to fix a toner image to a sheet by heating the toner image while conveying the sheet through the nip portion;
a shutter configured to move between a shielding position and an opening position, the shielding position being a position at which the shutter shields an inlet of the nip portion on an upstream side of the nip portion in a conveyance direction in which the sheet is conveyed through the nip portion, the opening position being a position at which the shutter opens the inlet of the nip portion;
a cartridge detachably attached to the main body frame and disposed on the second end side with respect to the fixing unit in the first direction, the cartridge including a photosensitive drum configured to rotate around a rotation axis that extends in the second direction and a developing roller configured to develop the toner image on the photosensitive drum by supplying toner to the photosensitive drum;
a rear opening/closing cover supported on the first end side of the main body frame in the first direction and configured to pivot with respect to the main body frame, the rear opening/closing cover being configured to rotate between an open position and a closed position, the opening position being a position at which the rear opening/closing cover is opened such that an access from the first end side of the main body frame to the fixing unit is allowed, the closed position being a position at which the rear opening/closing cover is closed such that the access from the first end side of the main body frame to the fixing unit is restricted;
a changing mechanism configured to change a state of the fixing unit between a first state where a pressure of the nip portion is a first pressure and a second state where the pressure is a second pressure lower than the first pressure or is zero;
a cover interlocking mechanism disposed on the third end side of the main body frame in the second direction, the cover interlocking mechanism being configured to interlock the changing mechanism and the rear opening/closing cover such that the fixing unit is in the first state in a case where the rear opening/closing cover is at the closed position, and the fixing unit is in the second state in a case where the rear opening/closing cover is at the open position; and
a shutter interlocking mechanism disposed on the third end side of the main body frame in the second direction, the shutter interlocking mechanism being configured to interlock attachment and detachment of the cartridge and a position of the shutter such that the shutter is at the opening position in a state where the cartridge is attached to the main body frame, and the shutter is at the shielding position in a state where the cartridge is not attached to the main body frame.

2. The image forming apparatus according to claim 1,
wherein in a case where the rotation axis is a first rotation axis,
the changing mechanism includes:
an arm configured to press the heating unit toward the pressing roller;
an urging member configured to urge the arm for causing the arm to press the heating unit toward the pressing roller; and
a cam configured to move the arm between a first position and a second position by rotating around a second rotation axis, the first position being a position at which the arm causes the fixing unit to be in the first state, the second position being a position at which the arm cause the fixing unit to be in the second state.

3. The image forming apparatus according to claim 2,
wherein the cartridge includes an engaging portion,
wherein the shutter interlocking mechanism includes:
a shutter link engaged with the shutter and configured to rotate the shutter between the shielding position and the opening position by pivoting around the second rotation axis, independently from the cam;
a pivot link configured to rotate the shutter link by rotating around the second rotation axis;
a linear-motion link configured to rotate the pivot link by moving in a direction from the first end portion toward the second end portion and in a direction from the second end portion toward the first end portion; and
an engaged portion configured to be engaged with the engaging portion of the cartridge, and
wherein the linear-motion link is configured to move in the direction from the second end portion toward the first end portion by the engaged portion engaging with the engaging portion in a process where the cartridge is attached to the main body frame, such that the shutter link is rotated by movement of the linear-motion link, and the shutter is rotated from the shielding position to the opening position by rotation of the shutter link.

4. The image forming apparatus according to claim 3,
wherein the cover interlocking mechanism includes:
a first link engaged with the rear opening/closing cover;
a second link engaged with the first link and configured to rotate around a third rotation axis that extends in the second direction;
a third link engaged with both of the second link and the changing mechanism and configured to move in the direction from the first end portion toward the second end portion and in the direction from the second end portion toward the first end portion; and
a fourth link engaged with the third link and configured to rotate around a fourth rotation axis that extends in the second direction.

5. The image forming apparatus according to claim 2,
wherein a position of the cover interlocking mechanism is different from a position of each of the arm, the urging member, and the cam of the changing mechanism in the second direction.

6. The image forming apparatus according to claim 4,
wherein the fourth link is disposed on outside with respect to the shutter link in the second direction.

7. The image forming apparatus according to claim 4,
wherein the fourth link is disposed on the fourth end side of the main body frame with respect to the linear-motion link in the second direction.

8. The image forming apparatus according to claim 7,
wherein a position of the fourth link in the second direction overlaps with a position of the engaged portion in the second direction.

9. The image forming apparatus according to claim 4,
wherein the changing mechanism includes a cam shaft configured to support the cam and the fourth link and extending in the second direction,
wherein the pivot link includes a support portion supported pivotably by the cam shaft, and
wherein the fourth link is disposed on outside with respect to the support portion in the second direction.

10. The image forming apparatus according to claim 3,
wherein the pivot link and the shutter link are disposed coaxially with the cam and supported to be rotatable independently from the cam.

11. The image forming apparatus according to claim 1,
wherein the heating unit includes a tubular film, and a heater disposed inside the film, and
wherein the pressing roller and the heater are configured to form the nip portion by sandwiching the film therebetween.

12. The image forming apparatus according to claim 1, further comprising:
an operation portion disposed on the fourth end side of the image forming apparatus in the second direction and configured to accept an operation for the image forming apparatus; and
a power supply disposed in the fourth end portion of the main body frame and configured to supply electric power to the operation portion.
